(19) United States
(12) Patent Application Publication
(10) Pub. No.: US 2024/0379931 A1
(43) Pub. Date: Nov. 14, 2024

(54) BATTERY ELECTRODES WITH POROSITY AND TORTUOSITY

(71) Applicant: UT-Battelle, LLC, Oak Ridge, TN (US)

(72) Inventors: Beth L. Armstrong, Oak Ridge, TN (US); Gabriel M. Veith, Knoxville, TN (US); Ethan Boeding, Watertown, MA (US)

(21) Appl. No.: 18/658,551

(22) Filed: May 8, 2024

Related U.S. Application Data
(60) Provisional application No. 63/464,652, filed on May 8, 2023.

(51) Int. Cl. H01M 4/04; H01M 4/02; H01M 4/62

(52) U.S. Cl. CPC H01M 4/0404; H01M 4/0471; H01M 4/625; H01M 2004/021; H01M 2004/027; H01M 2004/028

(57) ABSTRACT

A method of making a porous battery electrode includes the step of forming a mixture comprising a redox active electrode material, a conductive additive, and a sacrificial fugitive material dispersed in a solvent. The mixture is applied on a current collector, and then dried to evaporate the solvent. The sacrificial fugitive material is removed. The removed sacrificial fugitive material creates pores in the redox active electrode material, and forms a porous battery electrode with a porosity greater than 30%. A porous battery electrode having a porosity greater than 30-70 and a tortuosity of from 1-6, and a battery having the porous battery electrode comprising a porosity greater than 30% and a tortuosity of from 1-6, a counter electrode, a separator, and an electrolyte, are also disclosed.

### CROSS-REFERENCE TO RELATED APPLICATIONS

This application claims priority to U.S. 63/464,652 filed on May 8, 2023, entitled “TORTURE FREE ELECTRODES”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates generally to electrodes, and more particularly to methods of making battery electrodes.

### BACKGROUND OF THE INVENTION

A challenge confronting the development of battery electrodes is the ability to rapidly and reversibly intercalate alkali ions like lithium and sodium in the working electrode material. This is particularly true in materials such as silicon which has extremely high theoretical energy densities (capacity of ˜3600 milli-amp hours/gram (mAh/g) almost 11 times larger than traditional graphite electrodes (330 mAh/g)). One of the challenges with this large capacity is the expansion of the silicon by almost 330% at complete lithiation (charged state).

Similar expansions are observed for materials like tin, antimony, phosphorous and mixtures of materials like antimony-tin and aluminum-tin. The expansion of the silicon electrode causes significant structural and mechanical strains on the electrode. This includes closing off pores within the electrode with the commensurate expulsion of aprotic organic liquids made from mixtures of dimethyl carbonate, ethylene carbonate, and propylene carbonate with lithium containing salts such as lithium hexafluorophosphate (LiPF₆) and lithium bis(trifluoromethanesulfonyl)imide (LiTFSI).

An example of projected electrode loadings are shown in FIG. 1 for a hypothetical silicon electrode paired with a high capacity LiNi_{0.8}Mn_{0.1}Co_{0.1}O₂ (NMC811) cathode. FIG. 1 is a plot of energy density versus capacity of a silicon anode showing the need to form electrodes with weight loadings of electroactive silicon to be greater than 2 mAh/cm² to achieve cell energy densities greater than 350 Wh/kg in a full cell with LiNi_{0.8}Mn_{0.1}Co_{0.1}O₂ (NMC811) as a cathode.

The closing of pores and the expulsion of the liquid electrolyte results in a decrease in battery electrode performance as the ionic conductivity pathway changes from one that is a mixture of the liquid electrolyte (fast) and solid state diffusion through the formed lithium-silicon alloy (slow) to a predominately slow solid state diffusion pathway. As a result, the practical available capacity of the electrode decreases due to the long times (days) needed to fully lithiate the electrode. Further, the process of delithiation is significantly restricted by the same slow solid state diffusion to convert a Li—Si alloy back to a silicon electrode. Further, the 300+% expansion of silicon introduces significant strain upon the copper current collector resulting in buckling and mechanical shredding of the current collector.

The areal loading of silicon must be high enough to obtain batteries with energy densities greater than 350 Wh/kg. If the areal loading (mAh/cm²) is low the resulting cell will not get to high energy densities due to the mass of the copper current collector. However, if the loading is too high the strain and diffusion problems described above limit battery performance.

### SUMMARY OF THE INVENTION

A method of making a porous battery electrode includes the step of forming a mixture comprising a redox active electrode material, a conductive additive, and a sacrificial fugitive material dispersed in a solvent. The mixture is applied onto a current collector. The mixture on the current collector is dried to evaporate the solvent. The sacrificial fugitive material is removed. The removed sacrificial fugitive material creates pores in the redox active electrode material, and forms a porous battery electrode with a porosity greater than 30%. The method can further comprise adding a second redox active material.

The applying step can include at least one selected from the group consisting of cast, coating, and printing. The removing step can include at least one selected from the group consisting of volatilization, solubilization, and decomposition. The decomposition step can include heating the mixture.

The porosity of the electrode can be 30-70%. The tortuosity of the electrode can be from 1-6. The porosity of the electrode can be 50-70% and the tortuosity of the electrode can be 1.5-3.

The electrode can be a cathode and the redox active electrode material can include at least one selected from the group consisting of LiFePO₄, LiCoO₂, LiNi_{1-x-y}Co₁₋ₓMn_{y}O₂ (x<1 and y<1 and x+y<0.98), Li_{1.2}MnₓTi_{y}O₃F (x<1, y<1 and x+y=1), NCA (LiNi_{0.85}Al_{0.05}Co_{0.1}O₂), NaFeO₂, NaCoO₂, LiNi_{1/3}Mn_{1/3}Co_{1/3}O₂, Li(CoAl)₁O₂, Li_{1.2}(MnNiCo)_{0.8}O₂, LiMn₂O₄, Li₂MnO₃, LiMn_{1.5}Ni_{0.5}O₄, LiFePO₄, LiCoPO₄, LiNiPO₄, LiNiO₂, Li-V-O, Li₂Si—Mn, Fe, Ni—O₄, NaCrO₂, Na(Fe,Mn,Ni,Co)O₂, and Na₂(Ni,Fe,Mn)O₄. The electrode can be an anode and the redox active electrode material comprises at least one selected from the group consisting of graphite, silicon, tin, antimony, aluminum, phosphorous, platinum, gold, indium, Cu₂Sb, Mo₃Sb₇, and Cu₆Sn₅.

The sacrificial fugitive material can be natural and can include at least one selected from the group consisting of starches, gums, mosses, peptides and fats. The sacrificial fugitive material can be a starch and can comprise at least one selected from the group consisting of rice, potato, corn, and wheat. The sacrificial fugitive phase can be a gum and can comprise at least one selected from the group consisting of xanthan, carrageenan, chitosan, chitin, gelatin, and guar. The sacrificial fugitive material can be a moss and can comprise at least one selected from the group consisting of Irish Moss and lignin. The sacrificial fugitive material can be a peptide and can comprise at least one selected from the group consisting of alginic acid and glycine. The sacrificial fugitive material can be a fat and can comprise lecithin.

The sacrificial fugitive material can be synthetic and can include at least one selected from the group consisting of poly methyl methacrylate, styrene, polyvinyl alcohol, latex, polyethylene oxide, polyethylene glycol.

The sacrificial fugitive material can include spherical particles with a diameter between 100 nm and 30 micrometers. The sacrificial fugitive material can include ellipsoidal particles with an aspect ratio of 1 to 0.3. The sacrificial fugitive material can include at least two sizes, a larger size and a smaller size, wherein the larger size and the smaller size are made from different sacrificial fugitive materials having different decomposition temperatures.

The method can further utilize a polymer binder. The molecular weight (MW) of the binder can be MW >20,000. The electrode can be for an anode, and the binder can include at least one selected from the group consisting of polyimide, polyacrylic acid, cellulose, carboxy methyl cellulose, cellulose derivatives, propanol, polyvinyl difluoride, and styrene butyl rubber. The electrode can be for a cathode, and the binder can include at least one selected from the group consisting of polyimide, polyvinyl difluoride, carboxy methyl cellulose, cellulose derivatives, and styrene butyl rubber.

The decomposition temperature of the sacrificial fugitive material can be below the decomposition temperature of the binder. The electrode can include a conductive additive comprising carbon, and a decomposition temperature of the sacrificial fugitive phase can be below the decomposition temperature of the carbon in the conductive additive in the electrode. The decomposition temperature of the sacrificial fugitive material can be from 250° C. to 350° C.

The solvent can be a high dielectric solvent. The high dielectric solvent can include at least one selected from the group consisting of n-methyl pyrrolidone, water, ethanol, dimethyl formamide, and xylene. The sacrificial fugitive material can be insoluble in the solvent.

The mixture can be a suspension, and the mixture can further include a rheological aid. The rheological aid can have a molecular weight MW <20,000. The rheological aid can include at least one selected from the group consisting of carbon black, dispersants, poly acrylic acid, cellulose, and polyimide.

The conductive additive when for an anode can include at least one selected from the group consisting of carbon black, glassy carbon, carbon nanotubes, graphene, titanium diboride, zirconium diboride, carbon nanofibers, nickel, copper, stainless steel, and titanium. The conductive additive when for a cathode can include at least one selected from the group consisting of carbon black, glassy carbon, carbon nanotubes, graphene, carbon nanofibers, stainless steel, and aluminum.

The mixture can be a suspension. The mixture can be a slurry. The slurry can be applied to a current collector. There can be a preferential segregation of material forming a thin dense electrode structure at a position that is closer to the current collector and a mixture of less dense insoluble sacrificial fugitive particles, conductive additive, and binder materials at a position that is farther from the current collector. The method can include the step of adding a first slurry coating layer to the current collector having a first density, and then adding a second slurry coating layer having a second density.

A porous battery electrode according to the invention can have a porosity greater than 30-70 and a tortuosity of from 1-6. A battery according to the invention can include a porous battery electrode having a porosity greater than 30% and a tortuosity of from 1-6, a counter electrode, a separator, and an electrolyte.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a plot of stack energy (Wh/kg) vs the specific capacity of a Si anode (mAh/g).

FIG. 2A is a schematic perspective view of a cross section of an electrode according to the invention in a first stage of manufacture; FIG. 2 B is a schematic perspective view of a cross section of an electrode according to the invention in a second stage of manufacture.

FIG. 3 is a schematic diagram illustrating pore tortuosity (t) for t=1 (left), t>1 (center), and t>>>1 (right).

FIG. 4 block diagram of an electrode fabrication process according to the invention.

FIG. 5 is a plot of Temperature (° C.) vs. Time (min) illustrating thermal gravimetric data measured for potato starch in nitrogen. The Temperature profile is a dashed line. The solid line is the weight loss percent as a function of time and heating temperature.

FIG. 6 is a plot of Temperature (° C.) vs. Time (min) illustrating thermal gravimetric data measured for sucrose in nitrogen. The temperature profile is a dashed line. The solid line is the weight loss percent as a function of time and heating temperature.

FIG. 7 is a plot of Temperature (° C.) vs. Time (min) illustrating thermal gravimetric data measured for Irish Moss in nitrogen. The temperature profile is a dashed line. The solid line is the weight loss percent as a function of time and heating temperature.

FIG. 8 is a plot of Temperature (° C.) vs. Time (min) illustrating thermal gravimetric data measured for alginic acid in nitrogen. The temperature profile is a dashed line. The solid line is the weight loss percent as a function of time and heating temperature.

FIG. 9 is a plot of Temperature (° C.) vs. Time (min) illustrating thermal gravimetric data measured for rice starch in nitrogen. The temperature profile is a dashed line. The solid line is the weight loss percent as a function of time and heating temperature.

FIG. 10 is a plot of Temperature (° C.) vs. Time (min) illustrating a comparison of thermal gravimetric data measured for sucrose, Irish Moss, alginic acid, potato starch, and rice starch in nitrogen. The temperature profile is a dashed line. The solid line is the weight loss percent as a function of time and heating temperature.

FIG. 11 is a plot of Temperature (° C.) vs. Time (min) illustrating thermal gravimetric data measured for 5 micron polymethylmethacrylate (PMMA) in nitrogen. The temperature profile is a dashed line. The solid line is the weight loss percent as a function of time and heating temperature.

FIG. 12 is a plot of Temperature (° C.) vs. Time (min) illustrating thermal gravimetric data measured for 12 micron PMMA in nitrogen. The temperature profile is a dashed line. The solid line is the weight loss percent as a function of time and heating temperature.

FIG. 13 is a plot of Temperature (° C.) vs. Time (min) illustrating thermal gravimetric data measured for 20 micron PMMA in nitrogen. The temperature profile is a dashed line. The solid line is the weight loss percent as a function of time and heating temperature.

FIG. 14 is a plot of Temperature (° C.) vs. Time (min) illustrating a comparison of thermal gravimetric data measured for 5, 12, and 20 micron PMMA in nitrogen. The temperature profile is a dashed line. The solid line is the weight loss percent as a function of time and heating temperature.

FIG. 15 is a scanning electron microscope cross section image of a composite electrode without an added sacrificial fugitive material and without curing. The bottom is the copper current collector. The grey is the silicon particles. The top is the air side of the electrode.

FIG. 16 is a scanning electron microscope cross section image of a composite electrode without an added sacrificial fugitive material and with 350° C. curing. The bottom is the copper current collector. The grey is the silicon particles. The top is the air side of the electrode.

FIG. 17 is a scanning electron microscope cross section image of a composite electrode with Irish Moss added as a sacrificial fugitive material and with 350° C. curing. The bottom is the copper current collector. The grey is the silicon particles. The top is the air side of the electrode.

FIG. 18 is a scanning electron microscope cross section image of a composite electrode with added Alginic acid and with 350° C. curing. The bottom is the copper current collector. The grey is the silicon particles. The top is the air side of the electrode.

FIG. 19 is a scanning electron microscope cross section image of PMMA particles with a D₅₀ of 5 μm.

FIG. 20 is a scanning electron microscope cross section image of PMMA particles with a D₅₀ of 12 μm.

FIG. 21 is a scanning electron microscope cross section image of PMMA particles with a D₅₀ of 20 μm.

FIG. 22 A is a scanning electron microscope cross section image of a composite electrode with 10 wt %-5 μm D₅₀ PMMA added sacrificial fugitive material with 350° C. curing; FIG. 22 B is an identical image as FIG. 22 A but with the pores highlighted in black circles. The bottom is the copper current collector. The grey is the silicon particles. The top is the air side of the electrode.

FIG. 23 is a scanning electron microscope cross section image of a composite electrode with 30 wt %-5 μm D₅₀ PMMA added sacrificial fugitive material with 350° C. curing; FIG. 23 B is the identical image as FIG. 23 A but with pores highlighted in black circles. The bottom is the copper current collector. The grey is the silicon particles. The top is the air side of the electrode.

FIG. 24 A is a scanning electron microscope cross section images of a composite electrode with 45 wt %-5 μm D₅₀ PMMA added sacrificial fugive material with 350° C. curing; FIG. 24 B is the identical image as FIG. 24 A but with pores highlighted in black circles. The bottom is the copper current collector. The grey is the silicon particles. The top is the air side of the electrode.

FIG. 25 A is a scanning electron microscope cross section image of a composite electrode with 10 wt %-12 μm D₅₀ PMMA added sacrificial fugitive material with 350° C. curing; FIG. 25 B is the identical image as FIG. 25 A but with pores highlighted in black circles. The bottom is the copper current collector. The grey is the silicon particles. The top is the air side of the electrode.

FIG. 26 A is a scanning electron microscope cross section image of a composite electrode with 45 wt %-12 μm D₅₀ PMMA added sacrificial fugitive material with 350° C. curing; FIG. 26 B is the identical image as FIG. 26 A but with pores highlighted in black circles. The bottom is the copper current collector. The grey is the silicon particles. The top is the air side of the electrode.

FIG. 27 A is a scanning electron microscope cross section image of a composite electrode with 10 wt %-20 μm D₅₀ PMMA added sacrificial fugitive material with 350° C. curing; FIG. 27 B is the identical image as FIG. 27 A but with pores highlighted in black circles. The bottom is the copper current collector. The grey is the silicon particles. The top is the air side of the electrode.

FIG. 28 A is a scanning electron microscope cross section image of a composite electrode with 30 wt %-20 μm D₅₀ PMMA added sacrificial fugitive material with 350° C. curing; FIG. 28 B is the identical image as FIG. 28 A but with pores highlighted in black circles. The bottom is the copper current collector. The grey is the silicon particles. The top is the air side of the electrode.

FIG. 29 A is a scanning electron microscope cross section image of a composite electrode with 45 wt %-20 μm D₅₀ PMMA added sacrificial fugitive material with 350° C. curing; FIG. 29 B is the identical image as FIG. 29 A but with pores highlighted in black circles. The bottom is the copper current collector. The grey is the silicon particles. The top is the air side of the electrode.

FIG. 30 is a plot of electrochemical discharge capacity (mAh/gₛᵢ) as a function of cycle number measured for natural derived sacrificial fugitive material pore formers and neat silicon electrode.

FIG. 31 is a plot of electrochemical discharge capacity (mAh/gₛᵢ) as a function of cycle number measured for 5 μm PMMA (D₅₀) sacrificial fugitive material at 10, 30, and 45 wt % additive along with neat silicon electrode.

FIG. 32 is a plot of electrochemical discharge capacity (mAh/gₛᵢ) as a function of cycle number measured for 12 μm PMMA (D₅₀) sacrificial fugitive material at 10, 30, and 45 wt % additive along with neat silicon electrode.

FIG. 33 is a plot of electrochemical discharge capacity (mAh/gₛᵢ) as a function of cycle number measured for 20 μm PMMA (D₅₀) sacrificial fugitive material at 10, 30, and 45 wt % additive along with neat silicon electrode.

FIG. 34 is a comparison plot of cumulative electrochemical discharge capacity (mAh/gₛᵢ) as a function of cycle number measured for 5, 12, and 20 PMMA (D₅₀) sacrificial fugitive material at 10, 30, and 45 wt % additive along with neat silicon electrode.

FIG. 35 is a plot of tortuosity and porosity of theoretical Bruggeman Coefficient related to free-space transport impacted (tortuosity) by the geometry of the pores. A theoretical tortuosity of 1 and a porosity of 1 (or 100%) has no resistance to transport.

FIG. 36 is a plot of experimentally measured tortuosity and porosity for a standard neat silicon with 2.3 mA/cm² capacity.

FIG. 37 is a plot of experimentally measured tortuosity and porosity for a 4 mA/cm² electrode made with alginic acid sacrificial fugitive material with a D₅₀ via light scattering of 9.6 μm after curing for 60 minutes at 350° C. in argon.

FIG. 38 is a plot of experimentally measured tortuosity and porosity for a 4 mA/cm² electrode made with Irish Moss sacrificial fugitive material with a D₅₀ via light scattering of 12.8 μm after curing for 60 minutes at 350° C. in argon.

FIG. 39 is a plot of experimentally measured tortuosity and porosity for a 4 mA/cm² electrode made with potato starch sacrificial fugitive material with a D₅₀ via light scattering of 15.2 μm after curing for 60 minutes at 350° C. in argon.

FIG. 40 is a plot of experimentally measured tortuosity and porosity for a 4 mA/cm² electrode made with rice starch sacrificial fugitive material with a D₅₀ via light scattering of 0.7 μm after curing for 60 minutes at 350° C. in argon.

FIG. 41 is a plot of experimentally measured tortuosity and porosity for a 4 mA/cm² electrode made with sucrose sacrificial fugitive material with a D₅₀ via light scattering of 35.7 μm after curing for 60 minutes at 350° C. in argon.

FIG. 42 is a comparison plot of experimentally measured tortuosity and porosity for a 4 mA/cm² electrode made with naturally derived sacrificial fugitive materials.

FIG. 43 is a plot of experimentally measured tortuosity and porosity for a 4 mA/cm² electrode made with synthetic PMMA sacrificial fugitive material with a D₅₀ via light scattering of 5 μm after curing for 60 minutes at 350° C. in argon.

FIG. 44 is a plot of experimentally measured tortuosity and porosity for a 4 mA/cm² electrode made with synthetic PMMA sacrificial fugitive material with a D₅₀ via light scattering of 5 μm after curing for 60 minutes at 350° C. in argon.

FIG. 45 is a plot of experimentally measured tortuosity and porosity for a 4 mA/cm² electrode made with synthetic PMMA sacrificial fugitive material with a D₅₀ via light scattering of 5 μm after curing for 60 minutes at 350° C. in argon.

FIG. 46 is a comparison plot of experimentally measured tortuosity and porosity for a 4 mA/cm² electrode made with synthetic PMMA sacrificial fugitive material with a D₅₀ via light scattering of 5 μm after curing for 60 minutes at 350° C. in argon with various loadings of sacrificial fugitive material.

FIG. 47 is a plot of experimentally measured tortuosity and porosity for a 4 mA/cm² electrode made with synthetic PMMA sacrificial fugitive material with a D₅₀ via light scattering of 12 μm after curing for 60 minutes at 350° C. in argon.

FIG. 48 is a plot of experimentally measured tortuosity and porosity for a 4 mA/cm² electrode made with synthetic PMMA sacrificial fugitive material with a D₅₀ via light scattering of 12 μm after curing for 60 minutes at 350° C. in argon.

FIG. 49 is a plot of experimentally measured tortuosity and porosity for a 4 mA/cm² electrode made with synthetic PMMA sacrificial fugitive material with a D₅₀ via light scattering of 12 μm after curing for 60 minutes at 350° C. in argon.

FIG. 50 is a plot comparing experimentally measured tortuosity and porosity for a 4 mA/cm² electrode made with synthetic PMMA sacrificial fugitive material with a D₅₀ via light scattering of 12 μm after curing for 60 minutes at 350° C. in argon with various loadings of sacrificial fugitive material.

FIG. 51 is a plot of experimentally measured tortuosity and porosity for a 4 mA/cm² electrode made with synthetic PMMA sacrificial fugitive material with a D₅₀ via light scattering of 20 μm after curing for 60 minutes at 350° C. in argon.

FIG. 52 is a plot of experimentally measured tortuosity and porosity for a 4 mA/cm² electrode made with synthetic PMMA sacrificial fugitive material with a D₅₀ via light scattering of 20 μm after curing for 60 minutes at 350° C. in argon.

FIG. 53 is a plot of experimentally measured tortuosity and porosity for a 4 mA/cm² electrode made with synthetic PMMA sacrificial fugitive material with a D₅₀ via light scattering of 20 μm after curing for 60 minutes at 350° C. in argon.

FIG. 54 is a plot comparing experimentally measured tortuosity and porosity for a 4 mA/cm² electrode made with synthetic PMMA sacrificial fugitive material with a D₅₀ via light scattering of 20 μm after curing for 60 minutes at 350° C. in argon with various loadings of sacrificial fugitive material.

FIG. 55 is a plot of discharge capacity (mAh/gₛᵢ) of the 15^{th} cycle (1C rate) as a function of electrode tortuosity.

FIG. 56 is a plot of discharge capacity (mAh/gₛᵢ) of the 15^{th} cycle (1C rate) as a function of electrode porosity.

FIG. 57 is a plot of tortuosity (left) and porosity (right) as a function of natural sacrificial fugitive material melting point (° C.).

FIG. 58 is a plot of tortuosity (left) and porosity (right) as a function of size of the sacrificial fugitive material pore former (d₅₀)/melting point normalized to mass of sacrificial fugitive material added to electrode slurry. The dashed lines are added to assist in visualization.

FIG. 59 is a plot of discharge capacity (mAh/gₛᵢ) of the 15^{th} cycle (1C rate) as a function of size of the sacrificial fugitive material pore former (d₅₀)/melting point normalized to mass of sacrificial fugitive material pore former added to electrode slurry.

FIG. 60 is a schematic cross sectional image of an electrode having two differently sized sacrificial fugitive materials in a first stage of manufacture.

FIG. 61 is the schematic cross sectional image of FIG. 60, in a second stage of manufacture in which one of the sacrificial fugitive materials has decomposed first.

FIG. 62 is the schematic cross sectional image of FIG. 60, in a third possible stage of manufacture that is an alternative to the second stage shown in FIG. 61, in which the other sacrificial fugitive material has decomposed first.

FIG. 63 is the schematic cross sectional image of FIG. 60, showing all a final stage in which both sacrificial fugitive materials have decomposed.

FIG. 64 is a schematic cross sectional image of an electrode have first and second slurry layers.

FIG. 65 is a circuit diagram showing the transmission line model (R1+Q1/(R2+Ma3), Biologic) used to fit the measured spectra and calculate the corresponding MacMullin number (Nm).

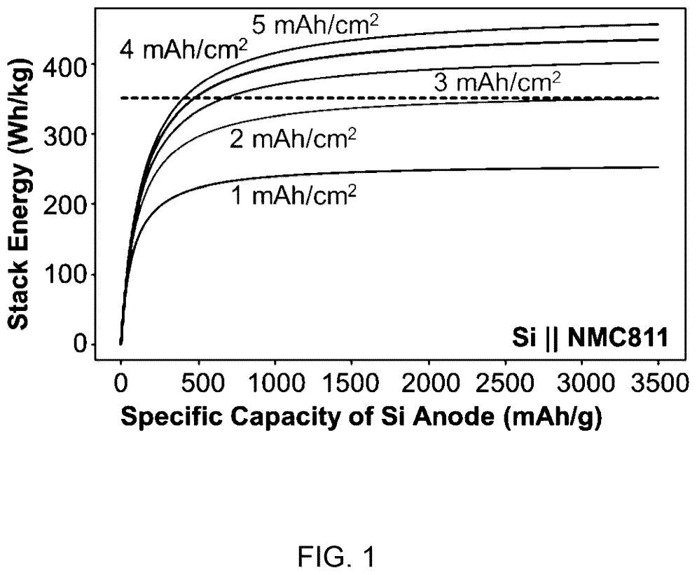

### DETAILED DESCRIPTION OF THE INVENTION

A method of making a porous battery electrode includes the step of forming a mixture comprising a redox active electrode material, a conductive additive, and a sacrificial fugitive material dispersed in a solvent. The mixture is applied to a current collector. The mixture is dried to evaporate the solvent. The sacrificial fugitive material is then removed. The removed sacrificial fugitive material creates pores in the redox active electrode material, and forming a porous battery electrode with a porosity greater than 30%. The insoluble or sparingly soluble sacrificial fugitive material can be particles of solid or insoluble liquid phase.

The applying step can be performed by different methods. The applying step can include at least one selected from the group consisting of cast, coating, and printing. Other methods are possible.

The removing step can vary depending on the characteristics of the mixture and the sacrificial fugitive material. The removing step can comprise at least one selected from the group consisting of volatilization, solubilization, and decomposition. Other methods are possible. The decomposition step chemically alters the sacrificial fugitive material. In one embodiment, the decomposition step comprises heating the mixture to cause the sacrificial fugitive material to undergo a chemical reaction.

The final porosity of the electrode is at least 30%, and can be as high as 760%. The porosity of the electrode can be 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70%. The porosity of the electrode can be within a range of any high value and low value selected from these values.

The tortuosity of the electrode can be is from 1 to 6. The tortuosity of the electrode can be 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, or 6. The tortuosity of the electrode can be within a range of any high value and low value selected from these values.

The porosity and tortuosity can be varied to arrive at electrodes with differing performance characteristics. In one embodiment, the porosity of the electrode is 50-70% and the tortuosity of the electrode is 1.5-3.

The invention is suitable for both the cathode and anode electrodes. The redox active material can be suited for either use. In the case where the electrode is a cathode, the redox active electrode material can comprise at least one selected from the group consisting of LiFePO₄, LiCoO₂, LiNi_{1-x-y}Co₁₋ₓMn_{y}O₂ (x<1 and y<1 and x+y<0.98), Li_{1.2}MnₓTi_{y}O₃F (x<1, y<1 and x+y=1), NCA (LiNi_{0.85}Al_{0.05}Co_{0.1}O₂), NaFeO₂, NaCoO₂, LiNi_{1/3}Mn_{1/3}Co_{1/3}O₂, Li(CoAl)₁O₂, Li_{1.2}(MnNiCo)_{0.8}O₂, LiMn₂O₄, Li₂MnO₃, LiMn_{1.5}Ni_{0.5}O₄, LiFePO₄, LiCoPO₄, LiNiPO₄, LiNiO₂, Li-V-O, Li₂Si—Mn, Fe, Ni—O₄, NaCrO₂, Na(Fe,Mn,Ni,Co)O₂, and Na₂(Ni,Fe,Mn)O₄. Other anode and cathode materials are possible. In the case where the electrode is an anode, the redox active electrode material can comprise at least one selected from the group consisting of graphite, silicon, tin, antimony, aluminum, phosphorous, platinum, gold, indium, Cu₂Sb, Mo₃Sb₇, and Cu₆Sn₅. In some cases more than one redox active material can be used.

The sacrificial fugitive material can take many forms. These materials should be insoluble or sparingly soluble in slurry solvents such as n-methyl pyrrolidone (NMP), dimethylformamide (DMF) and water. The sacrificial fugitive material can be a natural material. Examples of suitable natural materials include starches, gums, mosses, peptides and fats. Suitable starches include rice, potato, corn, and wheat. Suitable gums include xanthan, carrageenan, chitosan, chitin, gelatin, and guar. Suitable mosses include Irish Moss and lignin. Examples of suitable peptides include alginic acid and glycine. An example of a suitable fat is lecithin. Other materials for the sacrificial fugitive material are possible.

The sacrificial fugitive material can also be a synthetic material. Examples of suitable synthetic materials for the sacrificial fugitive material is synthetic and comprises at least one selected from the group consisting of poly methyl methacrylate, styrene, polyvinyl alcohol, latex, polyethylene oxide, polyethylene glycol.

The sacrificial fugitive material can be provided as particles, which can have different shapes and sizes which can be selected for the properties of the electrode that is desired. The sacrificial fugitive material can comprise spherical particles, ellipsoidal particles, or other shapes. The diameter of largest dimension of the sacrificial fugitive material particles can be from 100 nm to 30 micrometers. The largest dimension of the sacrificial fugitive material particles can be 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 234, 25, 26, 27, 28, 29, or 30 micrometers. The largest dimension of the sacrificial fugitive material particles can be with a range of any high value and low value selected from these values. The sacrificial fugitive material can comprise ellipsoidal particles with an aspect ratio of from 1 to 0.3.

More than one type of sacrificial fugitive particle can be used, with the other types of sacrificial fugitive material particles having different sizes or shapes, and/or being made of a different material. The sacrificial fugitive material can comprise at least two different sizes of particles, with a larger size and a smaller size. The larger size and the smaller size for example can be made from different sacrificial fugitive materials having different decomposition temperatures.

A binder can be used in some cases to hold together the redox active material in the final electrode. The binder can be made of differing materials, but in one embodiment comprises a polymer binder. The molecular weight (MW) of the binder can be MW >20,000. The binder can be chosen to be suitable for the redox material of an anode or a cathode. The binder can be for an anode, and the binder can comprise for example polyimide, polyacrylic acid, cellulose, carboxy methyl cellulose, cellulose derivatives, propanol, polyvinyl difluoride, and/or styrene butyl rubber. The binder can be for a cathode, and the binder can comprise polyimide, polyvinyl difluoride, carboxy methyl cellulose, cellulose derivatives, and/or styrene butyl rubber.

Where the removal of the sacrificial fugitive particles is by heating and a binder is to be used, the decomposition temperature of the sacrificial fugitive material should be below the decomposition temperature of the binder.

The electrode includes a conductive additive to improve the conductivity of the final electrode. The conductive additive can be selected from several suitable materials. The conductive additive can comprise carbon. A decomposition temperature of the sacrificial fugitive phase should be below the decomposition temperature of the carbon in the conductive additive in the electrode, usually about 600° C. The material of the conductive additive can be changed depending on whether the electrode is for a cathode or an anode. The conductive additive for an anode can for example comprise carbon black, glassy carbon, carbon nanotubes, graphene, titanium diboride, zirconium diboride, carbon nanofibers, nickel, copper, stainless steel, and/or titanium. The conductive additive for a cathode can for example comprise at least one selected from the group consisting of carbon black, glassy carbon, carbon nanotubes, graphene, carbon nanofibers, stainless steel, and/or aluminum.

The decomposition temperature of the sacrificial fugitive material can vary, where decomposition is the method of removal. The sacrificial fugitive material should have as high a melting point as possible to avoid restructuring during heating but low enough to thermally decompose during thermal processing without decomposing the polymer binder. The decomposition temperature of the sacrificial fugitive material can in one example be from 250° C. to 350° C. Other decomposition temperatures are possible.

Different solvents are possible and can be selected for the composition for the redox active material, sacrificial fugitive material, and binder if present. The solvent can be a high dielectric solvent. The high dielectric solvent can vary. In one example, the high dielectric solvent comprises n-methyl pyrrolidone, water, ethanol, dimethyl formamide, and/or xylene. The sacrificial fugitive material can be insoluble in the solvent.

The mixture can be a suspension, and a rheological aid can be used to facilitate the use of such a suspension during the application of the suspension to the current collector. The rheological aid can in some cases have a molecular weight MW<20,000. Different materials can be used as a rheological aid. For example, the rheological can comprise carbon black, dispersants, poly acrylic acid, cellulose, and/or polyimide.

The mixed can be a slurry or a suspension. The slurry can be applied to a current collector such that there is a preferential segregation of redox active material without much sacrificial fugitive material. This will form a thin dense electrode structure at a position that is closer to the current collector. Further form the current collector, there is more sacrificial fugitive material and this will form a more porous electrode structure farther from the current collector. The result is that the electrolyte with the cation will readily penetrate the pores, but will not touch the current collector where the electrolyte sometimes will react with the material making up the current collector. This result can also be accomplished by utilizing more that one coating of the mixture, where the applied layers closest to the current collector have less or no sacrificial fugitive material, and subsequent layer farther from the current collector have more of the sacrificial fugitive material. The first slurry coating layer that is applied to the current collector can have a first density, and the second slurry coating layer that is applied to the current collector can have a second density, usually less than the density of the first coating layer.

A porous battery electrode made according to the invention can have a porosity greater than 30-70 and a tortuosity of from 1-6. A battery can be formed comprising the porous battery electrode that has a porosity greater than 30% and a tortuosity of from 1-6, a counter electrode, a separator, and an electrolyte.

In one aspect, the technologies described herein provides a method to make a porous battery electrode with a porosity greater than 50%, the method comprising forming a slurry/suspension comprising a working electrode material (e.g., silicon or LiNi_{0.8}Mn_{0.1}Co_{0.1}O₂ (811), etc.), a conductive additive and rheological aid (e.g., carbon black), a polymer binder, an optional second redox active material (e.g., graphite), and a sacrificial insoluble/sparingly fugitive phase dispersed in a high dielectric solvent (e.g., n-methyl pyrrolidone, water, ethanol, xylene, dimethyl formamide and mixtures therein); mixing the slurry/suspension; casting the slurry/suspension on a current collector; drying to evaporate the solvent; and curing to obtain a porous battery electrode with a porosity greater than 50%.

The slurry/suspension is applied to a current collector like copper where there is a homogenous distribution of the insoluble sacrificial sacrificial fugitive materials through the electrode. These insoluble sacrificial fugitive materials have a decomposition temperature less than the decomposition temperature of the polymer binder. The insoluble sacrificial fugitive materials thermally decompose in an inert gas like argon or nitrogen or under vacuum leaving an interconnected network of pores within the electrode.

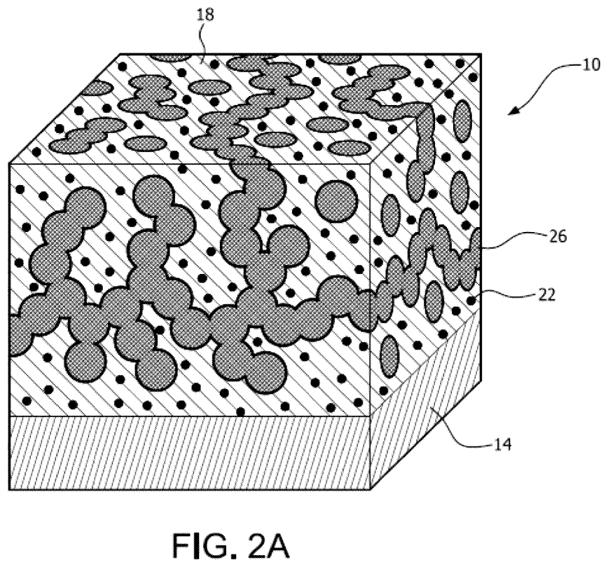

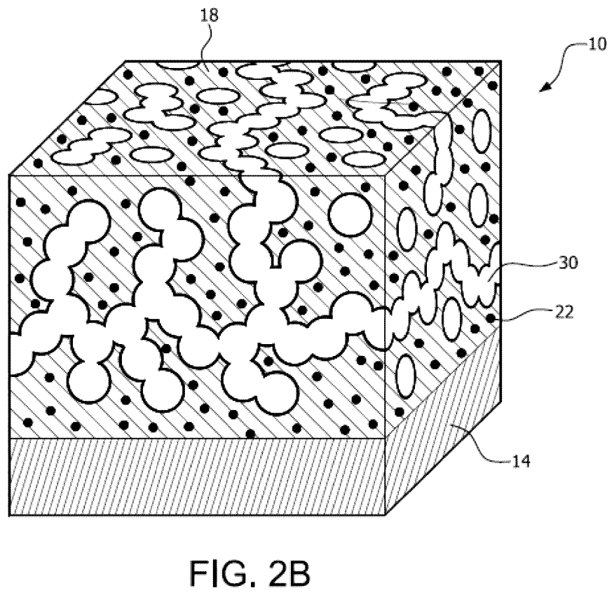

A schematic of this process is shown in FIGS. 2A-2B, There is shown in FIG. 2A an electrode 10 with a current collector 14 and a mixture have a redox active material 18, a conductive additive 11, and a sacrificial fugitive material 26. As shown in FIG. 2B, when the sacrificial fugitive material 26 is removed as for example by heating, pores 30 are created.

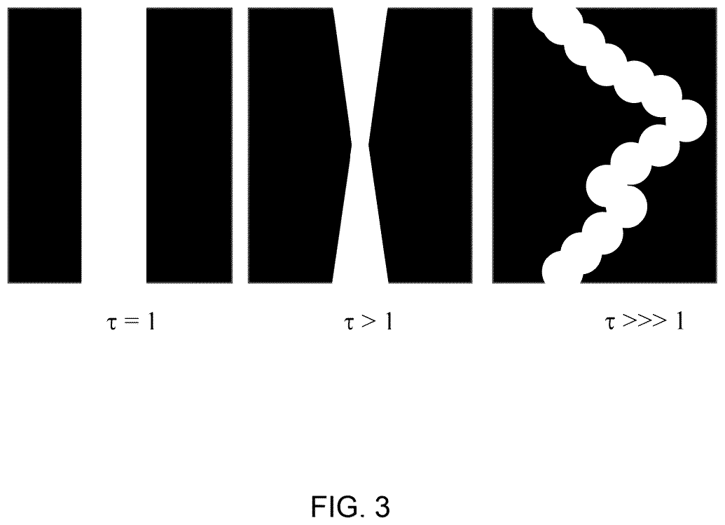

In another aspect, the technologies described herein provide a battery comprising the porous electrode described herein, a counter electrode, a separator, and an electrolyte. For electrodes with extremely high weight loading high porosity or low tortuosity is required to reduce lithium ion diffusion limitations and restrictions. A schematic representing tortuosity is shown in FIG. 3. FIG. 3 shows tortuosity (t) as represented for different pore structures, with t=1, t>1, and t>>>1.

The counter electrode in the battery can be a standard battery formulation without a sacrificial fugitive material, or can be made porous and tortuous with a sacrificial fugitive material as described herein.

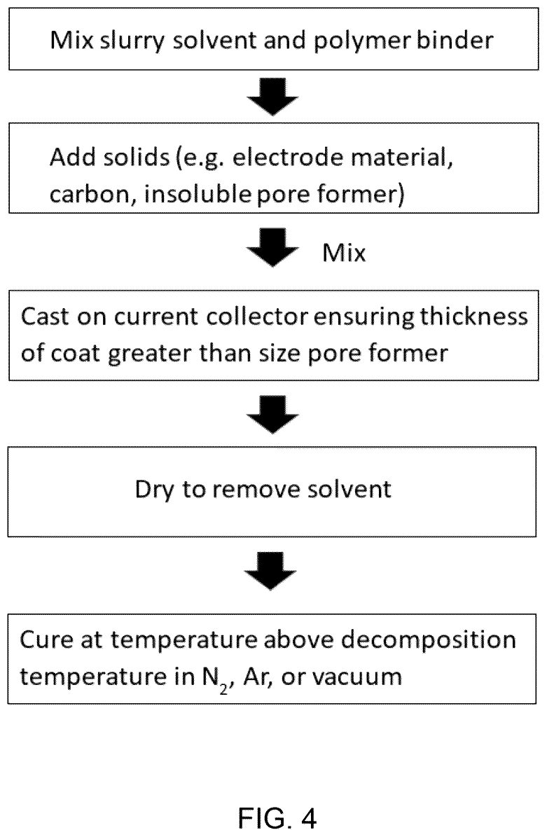

The materials are mixed using standard battery electrode formation protocols as schematically represented in FIG. 4. Care should be taken to avoid high energy processes which will change the insoluble sacrificial fugitive material size through attrition.

A more preferable geometry entails the preferential segregation of electroactive material forming a thin dense electrode structure close to the current collector and a mixture of less dense insoluble sacrificial fugitive phases and electroactive and carbon and binder materials closer to the outer surface of the cast electrode. The slurry solvent is evaporated leaving a composite material comprising the silicon, polymer binder, optional secondary redox active material, and insoluble/sparingly soluble fugitive phase. These insoluble sacrificial fugitive materials have a decomposition temperature less than the decomposition temperature of the polymer binder. The insoluble sacrificial fugitive materials thermally decompose in an inert gas like argon or nitrogen or under vacuum leaving an interconnected network of pores within the electrode. The porous electrode can be formed into a battery when combined with a counter electrode and a separator and electrolyte to form a battery.

The electrode is thermally treated under inert gas like argon or nitrogen where the fugitive thermally decomposes to form a gas and leaving behind a porous network templated from the insoluble/sparingly soluble fugitive phase. The resulting electrode has a porosity greater than 30% and a tortuosity from 6 to 1 where a tortuosity of 6 is highly tortuous making ion diffusion extremely difficult due to the convoluted path and a tortuosity of 1 is negligible and allows fast ion transport.

The insoluble or sparingly soluble sacrificial fugitive particles can be solid or an insoluble liquid phase of artificial polymers like polymethyl methacrylate (PMMA) or naturally derived starches, polysaccharides and amino acids or mixtures with predetermined sizes through controlled growth or controlled materials processing such a milling or attrition to predetermined sizes. The insoluble or sparingly soluble sacrificial fugitive particles should decompose thermally without needing oxygen.

The insoluble or sparingly soluble sacrificial fugitive material can be monodispersed or polydispersed sizes with an ideal size approximately 3 times the size of the active redox material like silicon to accommodate a 300% volume expansion during cycling of the lithiated silicon. The insoluble or sparingly soluble sacrificial fugitive phase should have a thermal decomposition temperature below the thermal decomposition temperature of the polymer binder to prevent binder loss.

The insoluble or sparingly soluble sacrificial fugitive material phase should comprise 10-60 volume percent of the dried slurry materials. The insoluble or sparingly soluble sacrificial fugitive material phase should comprise 1, 2, 3, 4, 5, 6, 7, 8, 9, 10, 11, 12, 13, 14, 15, 16, 17, 18, 19, 20, 21, 22, 23, 234, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 volume percent of the dried slurry materials, and can be within a range of any high value and low value selected from these values. Further, the weight percents of the non-fugitive materials should comprise a mass ratio of 40-99 weight percent active material (e.g., silicon) with the remaining fraction consisting of a mixture of binder, carbon black and secondary redox materials like graphite. The weight percent of the non-fugitive material that is silicon can be 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 weight percent, and can be within a range of any high value and low value selected from these values.

Oxidative removal of the insoluble sacrificial fugitive material is possible for oxide electrodes like LiCoO₂, LiNiₓMn_{y}Co_{z}O₂ where X> or equal to 3, Y< or equal to 3, and Z is < or equal to 3, LiNiₓMn_{y}Co_{z}Al_{Q}O₂X> or equal to 8, Y< or equal to 1, and Z is < or equal to 1 and Q is < or equal to 1. The temperature should be kept below 200° C. to avoid oxidation of the polymer binder. In the event of a binder free cell the annealing of these cathodes should be kept below 300° C. to avoid oxidation of carbon and aluminum current collectors.

Oxidative removal of the sacrificial fugitive material is possible for oxide anode electrodes like Li₄Ti₅O₁₂, Cu₂O, FeO, metal fluorides such as CuF₂, BiF₂, FeF₂, FeF₃, CoF₂, CoF₃, NiF₂, and NiF₂. The temperature should be kept below 200° C. to avoid oxidation of the polymer binder. In the event of a binder free cell the annealing of these cathodes should be kept below 300° C. to avoid oxidation of carbon. Further, the temperature should be kept below 200° C. to avoid oxidation of copper current collector.

The ratio of the sacrificial fugitive material particle diameter (μm) to melting point should be as small as possible to prevent slumping or flow of the insoluble sacrificial fugitive material and resulting loss of electrical interconnections. Ideally the melting point of the sacrificial fugitive material should be close to the decomposition temperature to avoid pore collapse or the melted insoluble sacrificial fugitive material interacting with the binder, active electrode material, and carbon. This ratio of sacrificial fugitive material diameter (μm) to melting point can be made small by adjusting the melting point to be high or reducing the size of the sacrificial fugitive material particles to be small thus reducing the amount of material within the pores that can be restructured.

The cured electrode after removal of the sacrificial fugitive material is then integrated within an electrochemical cell to form one or both of the working electrode (anode and/or cathode). The electrode can be filled with aprotic liquid electrolytes such as 1.2M LiPF₆ in ethylene carbonate/dimethyl carbonate.

The resulting pore structure aids in the wetting of the electrode and infiltration of the aprotic liquid electrolyte resulting in faster cell production rates due to the elimination of diffusion into narrow or constricted pores typical of composite silicon electrodes. Typical times are in seconds versus hours for traditional electrodes which is advantages to avoid deleterious chemical reactions between redox active materials like silicon and aprotic battery electrolytes.

A similar pore structure can be developed for cathode architectures using the same process though instead of silicon electrodes could include LiCoO₂, LiNiₓMn_{y}Co_{z}O₂ where X> or equal to 3, Y< or equal to 3, and Z is < or equal to 3, LiNiₓMn_{y}Co_{z}Al_{Q}O₂ X> or equal to 8, Y< or equal to 1, and Z is < or equal to 1 and Q is < or equal to 1.

The resulting pore structure could also be infiltrated with a solid electrolyte powder or sol gel precursor to aid in the formation of an all solid state battery.

The maximum pore diameter should be no larger than 10 microns to ensure suitable energy density of the electrode.

Traditional approaches to make porous electrodes involve the addition of added solvent, freeze tape casting, laser drilling, electrodeposition of materials, reactive ion etching, and catalytically promoted nanowire growth. These processes are time intensive and difficult to scale or require the use of expensive seed layers like gold to grow nanowires that will become electrodes.

Example insoluble pore forming sacrificial fugitive materials include those derived from natural products like Irish Moss (Carrageen), Alginic Acid, Sucrose, Rice Starch, Potato Starch. Artificial insoluble sacrificial fugitive materials include polymethyl methacrylate (PMMA), latex, styrene, and polyacrylic acid.

The size of the sacrificial fugitive material particles can be tailored to direct the result electrodes porosity and tortuosity. Controlling the size is done through milling, grinding, or other attrition process from a large feedstock material. Alternatively, the feedstock can be heated to melting to form a large feedstock material or smaller aggregates. Polymer size can be controlled through standard growth and cooling processes to adjust the size of the resulting particles.

TABLE 1
Melting points of sacrificial fugitive materials.

| Insoluble Sacrificial Fugitive Material | Melting Point (° C.) |
|---|---|
| Irish Moss | 190 |
| Sucrose | 186 |
| Alginic Acid | 300 |
| Rice Starch | 276 |
| Potato Starch | 258 |
| PMMA | 160 |
| Latex | 120 |
| Styrene | 145 |
| Polyacrylic Acid | 116 |

Residue is not an issue provided it is mostly carbon containing and not redox active. Suitable materials include C—O ash and C—N ash.

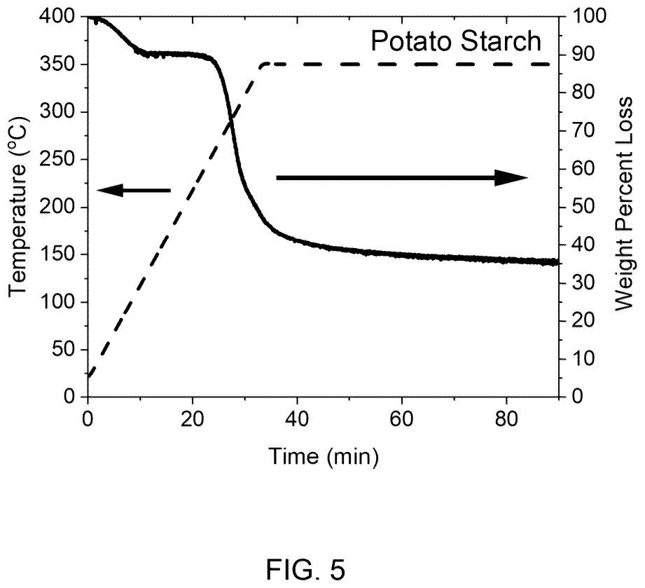

An example of a suitable insoluble sacrificial fugitive material is shown in FIG. 5. FIG. 5 shows thermal gravimetric data measured for potato starch in nitrogen. The temperature profile is a dashed line. The solid line is the weight loss percent as a function of time and heating temperature. Thermal gravimetric analysis data measured in N₂ is shown as measured for Potato Starch (15.2 μm D₅₀ particle size measured by light scattering) shows thermal decomposition below 350° C. This sacrificial fugitive material leaves approximately 36 wt % residue behind that is not electrochemically active with intercalating lithium ions.

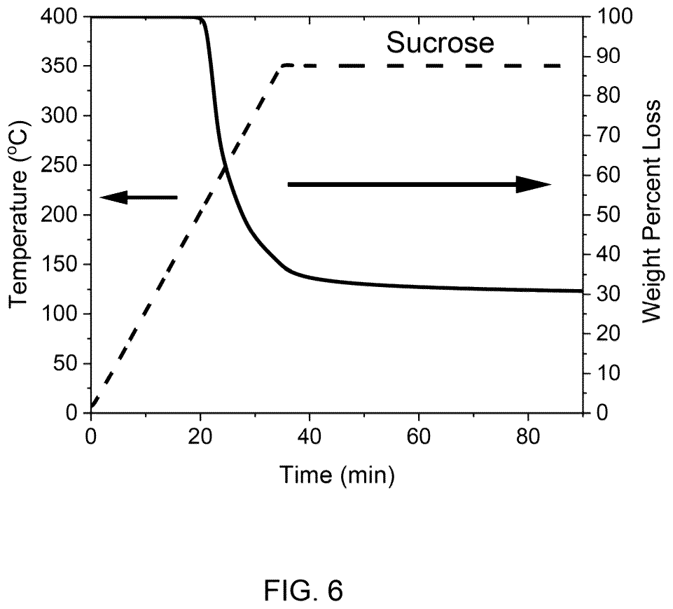

An example of a suitable insoluble sacrificial fugitive material is shown in FIG. 6. FIG. 6 shows thermal gravimetric data measured for sucrose in nitrogen. The temperature profile is a dashed line. The solid line is the weight loss percent as a function of time and heating temperature. Thermal gravimetric analysis data measured in N₂ is shown as measured for Sucrose (35.7 μm D₅₀ particle size measured by light scattering) shows thermal decomposition below 350° C. This sacrificial fugitive material leaves approximately 31 wt % residue behind that is not electrochemically active with intercalating lithium ions.

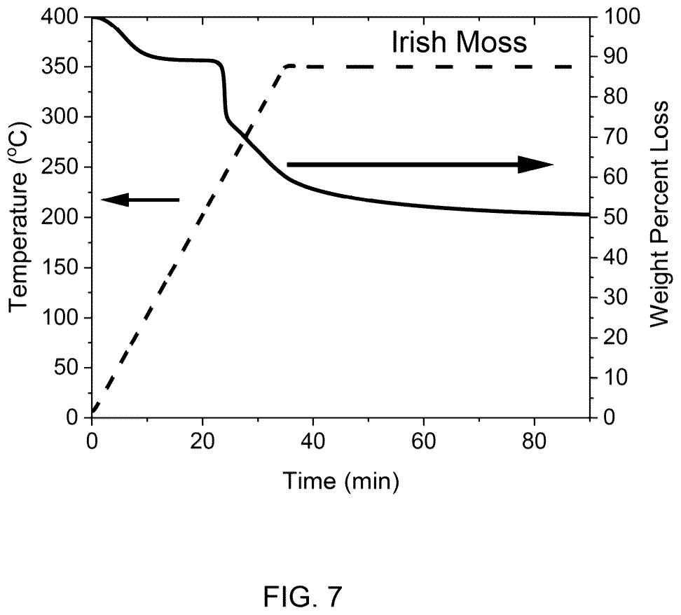

An example of a suitable insoluble sacrificial fugitive material is shown in FIG. 7. FIG. 7 shows thermal gravimetric data measured for Irish Moss in nitrogen. The temperature profile is a dashed line. The solid line is the weight loss percent as a function of time and heating temperature. Thermal gravimetric analysis data measured in N₂ is shown as measured for Irish Moss (12.8 μm D₅₀ particle size measured by light scattering) shows thermal decomposition below 350° C. This sacrificial fugitive material leaves approximately 51 wt % residue behind that is not electrochemically active with intercalating lithium ions.

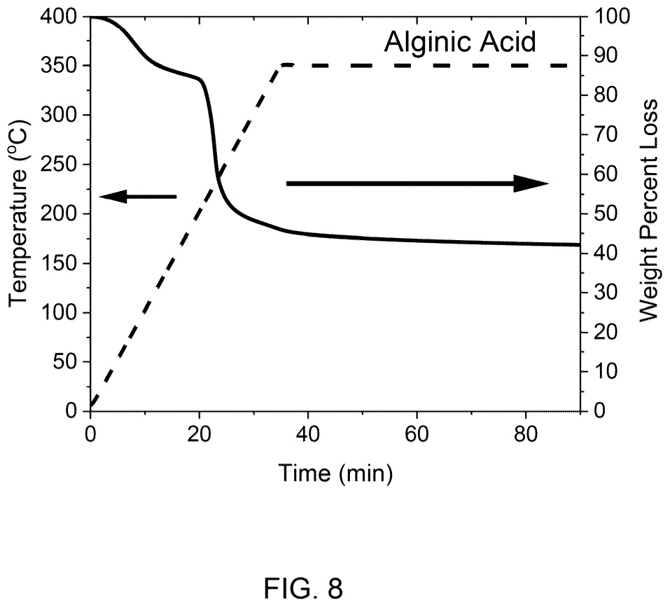

An example of a suitable sacrificial fugitive material is shown in FIG. 8. FIG. 8 shows thermal gravimetric data measured for alginic acid in nitrogen. The temperature profile is a dashed line. The solid line is the weight loss percent as a function of time and heating temperature. Thermal gravimetric analysis data measured in N₂ is shown as measured for Alginic Acid (9.6 μm D₅₀ particle size measured by light scattering) shows thermal decomposition below 350° C. This sacrificial fugitive material leaves approximately 42 wt % residue behind that is not electrochemically active with intercalating lithium ions.

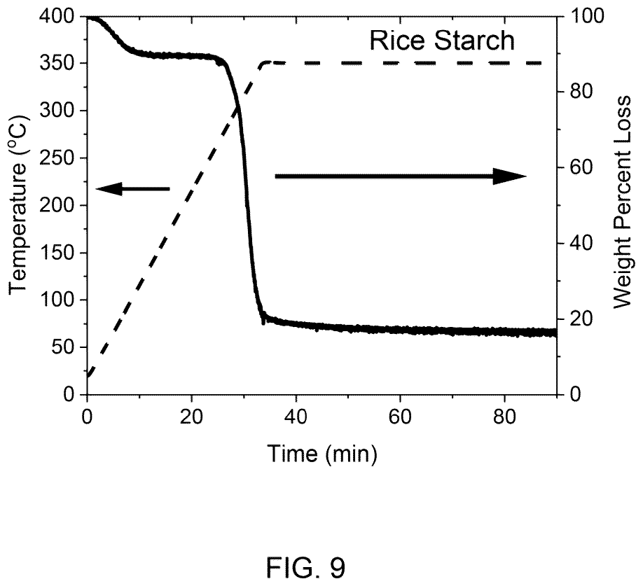

An example of another sacrificial fugitive material is shown in FIG. 9. FIG. 9 shows thermal gravimetric data measured for rice starch in nitrogen. The temperature profile is a dashed line. The solid line is the weight loss percent as a function of time and heating temperature. Thermal gravimetric analysis data measured in N₂ is shown as measured for Rice Starch (0.7 μm D₅₀ particle size measured by light scattering) shows thermal decomposition below 350° C. This sacrificial fugitive material leaves approximately 18 wt % residue behind that is not electrochemically active with intercalating lithium ions.

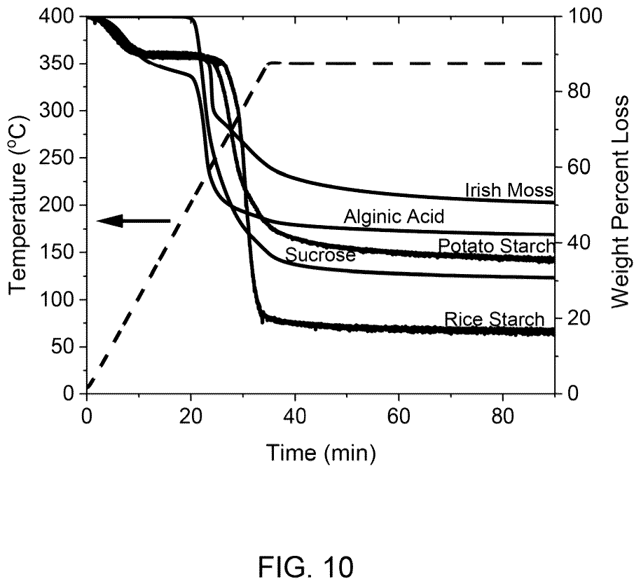

A comparison of the above naturally derived sacrificial fugitive materials is presented in FIG. 10. FIG. 10 shows the combined thermal gravimetric analysis weight loss data (right) for Alginic acid, Irish Moss, Potato starch, Rice starch and sucrose along with the heating profile (left).

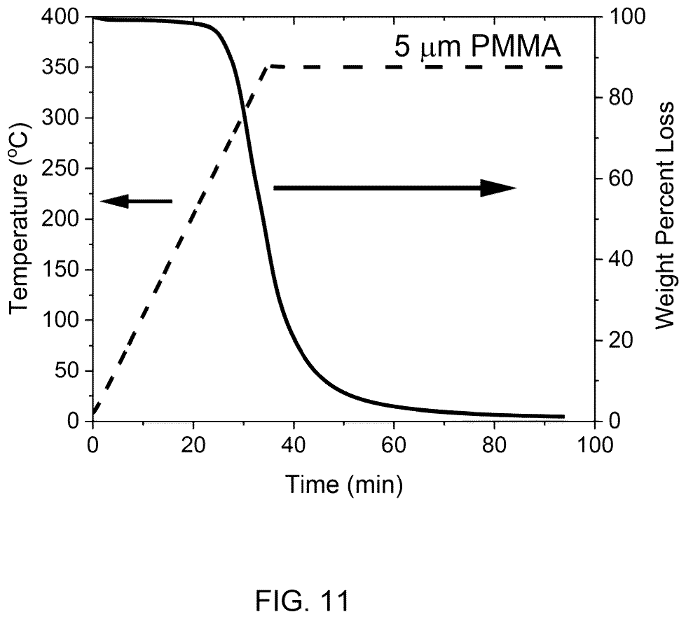

An example of an artificial suitable sacrificial fugitive material is shown in FIG. 11. FIG. 11 shows thermal gravimetric data measured for 5 micron PMMA particles in nitrogen. The temperature profile is a dashed line. The solid line is the weight loss percent as a function of time and heating temperature. Thermal gravimetric analysis data measured in N₂ is shown as measured for PMMA (5 μm D₅₀ particle size measured by light scattering) shows thermal decomposition below 350° C. This sacrificial fugitive material leaves approximately 0 wt % residue behind that is not electrochemically active with intercalating lithium ions.

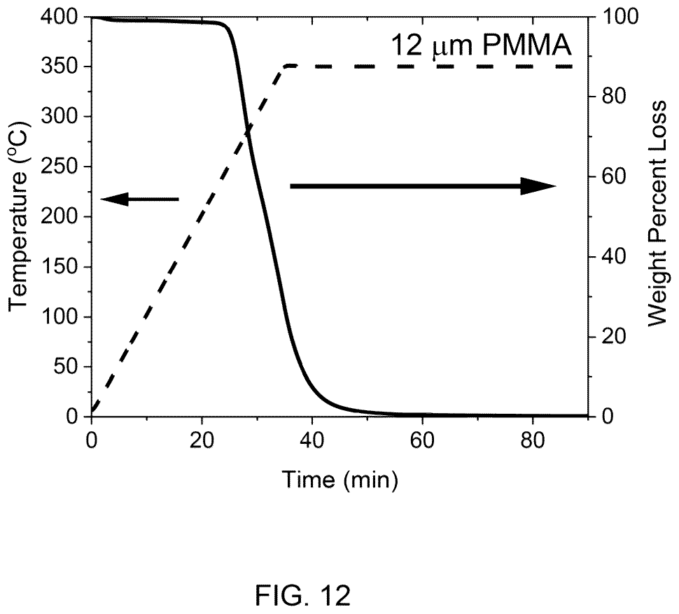

Another example of an artificial sacrificial fugitive material is shown in FIG. 12. FIG. 12 shows thermal gravimetric data measured for 12 micron PMMA particles in nitrogen. The temperature profile is a dashed line. The solid line is the weight loss percent as a function of time and heating temperature. Thermal gravimetric analysis data measured in N₂ is shown as measured for PMMA (12 μm D₅₀ particle size measured by light scattering) shows thermal decomposition below 350° C. This sacrificial fugitive material leaves approximately 0 wt % residue behind that is not electrochemically active with intercalating lithium ions.

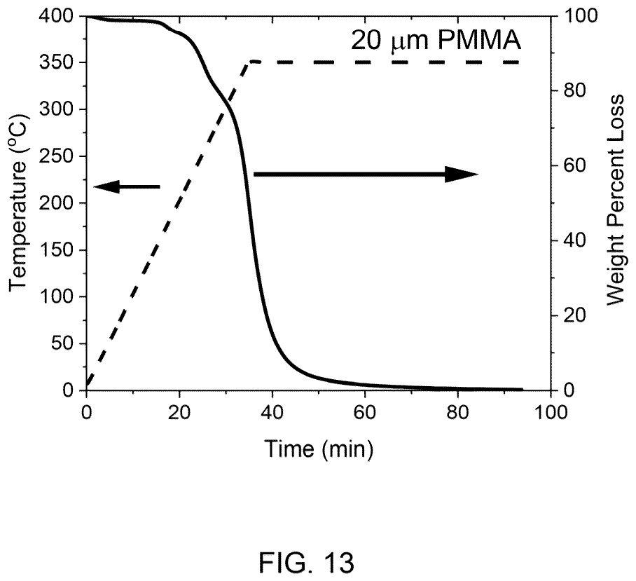

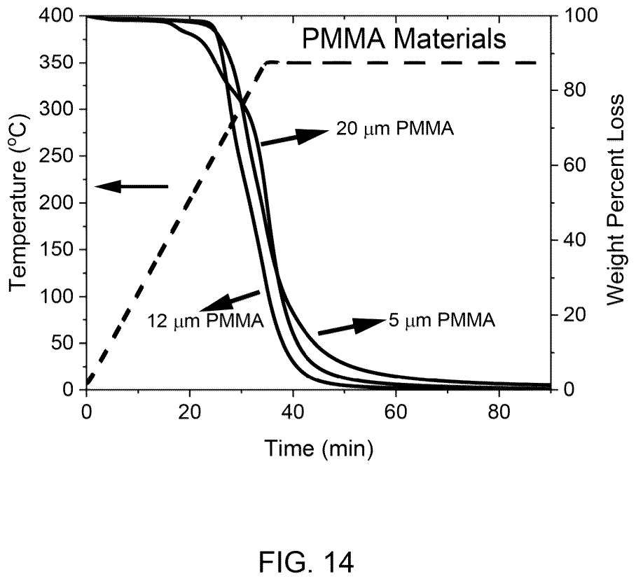

Another artificial sacrificial fugitive material is shown in FIG. 13. FIG. 13 shows thermal gravimetric data measured for 20 micron PMMA particles in nitrogen. The temperature profile is a dashed line. The solid line is the weight loss percent as a function of time and heating temperature. Thermal gravimetric analysis data measured in N₂ is shown as measured for PMMA (20 μm D₅₀ particle size measured by light scattering) shows thermal decomposition below 350° C. This sacrificial fugitive material leaves approximately 0 wt % residue behind that is not electrochemically active with intercalating lithium ions. FIG. 14 is a plot of Temperature (° C.) vs. Time (min) illustrating a comparison of thermal gravimetric data measured for 5, 12, and 20 micron PMMA in nitrogen.

### Examples

In the examples below a silicon electrode was fabricated such that the target silicon loading was 4 mA/cm² in an 80% silicon/10% carbon black (C45 type), 10% polyimide binder (P84 type). The polyimide binder was mixed in n-methyl pyrrolidone solvent. The solids were added to the binder mixture and combined through low energy mixing. The sacrificial fugitive material included natural products Irish Moss (Carrageen), Alginic Acid, Sucrose, Rice Starch, Potato Starch, and artificial insoluble sacrificial fugitive materials include polymethyl methacrylate (PMMA) which were added at 10, 30 and 45 wt % solids in the slurry assuming complete removal with thermal heating. To cure the polyimide binder the electrodes are heated in argon to 350° C. for one hour to cross link the polyimide and decompose out the insoluble sacrificial fugitive material.

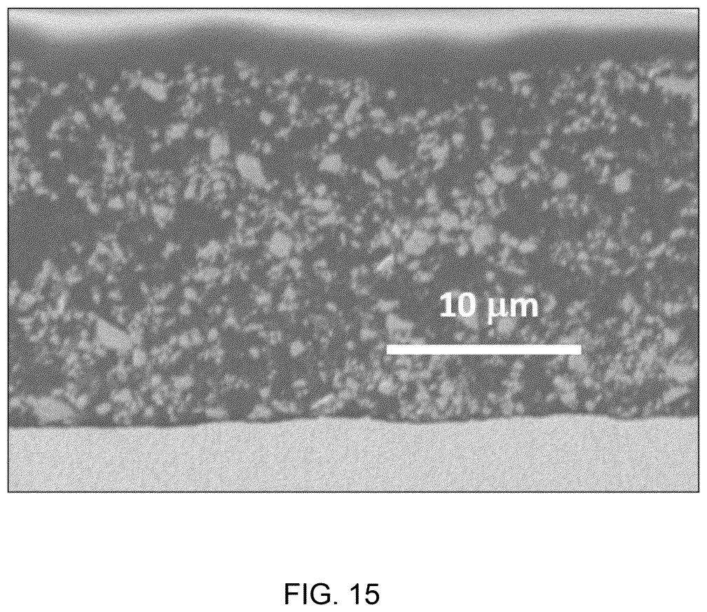

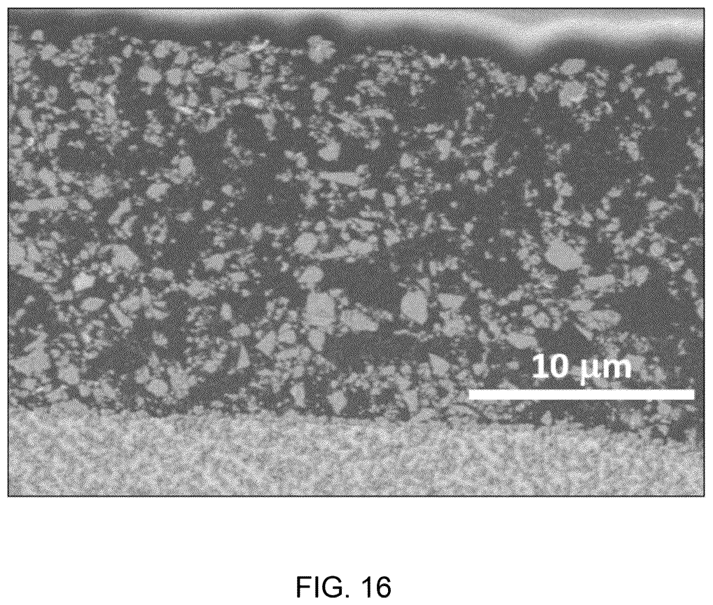

An electrode was formed without a sacrificial fugitive material (neat silicon). A SEM cross section of this electrode is presented in FIG. 15. The bottom is the copper current collector. The grey is the silicon particles. The top is the air side of the electrode. This electrode has a porosity of 30% but is difficult to image in the SEM due to the contrast match between carbon black and the epoxy infiltrated within the electrode to enable cross sectioning. This electrode was cured at 120° C. for 20 minutes to remove n-methyl pyrrolidone solvent. FIG. 16 shows the neat electrode after curing at 350° C. The bottom is the copper current collector. The grey is the silicon particles. The top is the air side of the electrode. The porosity of the electrode is 30% but is difficult to image in the SEM due to the contrast match between carbon black and the epoxy infiltrated within the electrode to enable cross sectioning.

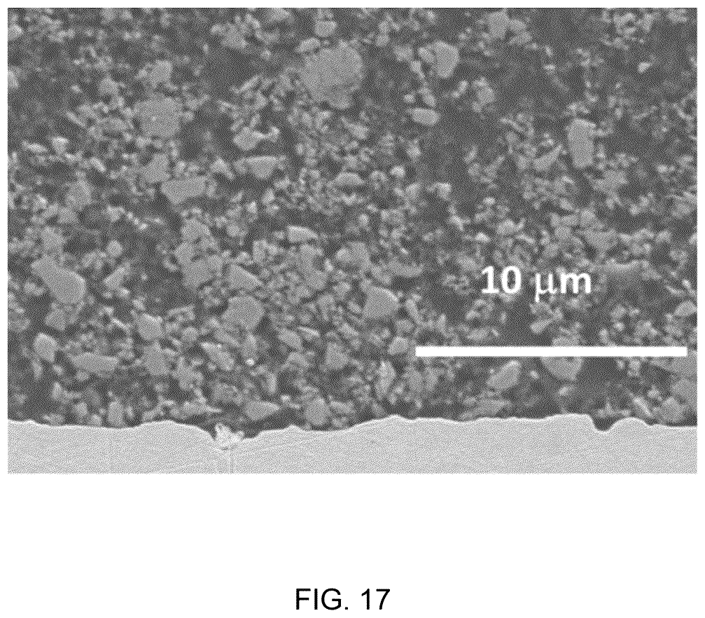

An electrode formed with 10 wt % Irish Moss cured at 350° C. in argon was embedded in epoxy and cross sectioned to image in the SEM. This data is presented in FIG. 17. The bottom is the copper current collector. The grey is the silicon particles. The top is the air side of the electrode. From the data one notices more vertically aligned passages compared to the neat electrode (FIG. 16).

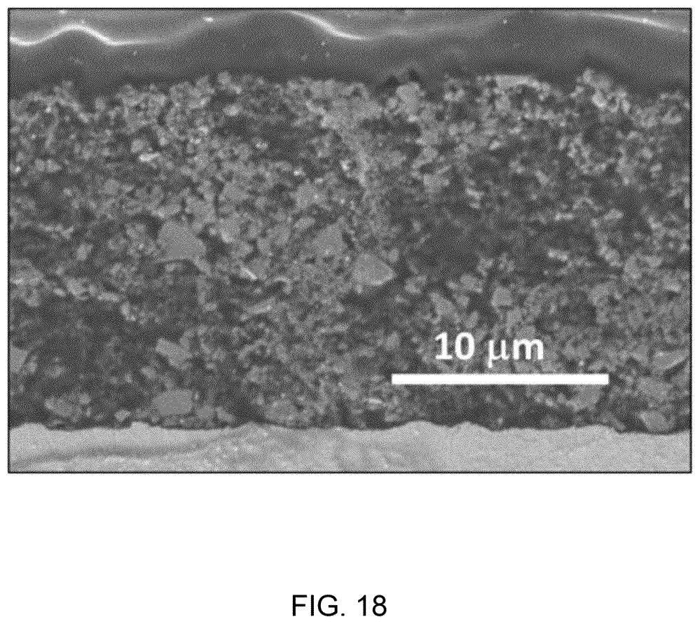

An electrode formed with 10 wt % Alginic Acid and cured at 350° C. in argon was embedded in epoxy and cross sectioned to image in the SEM. This data is presented in FIG. 18. The bottom is the copper current collector. The grey is the silicon particles. The top is the air side of the electrode. From the data one notices more vertically aligned passages compared to the neat electrode (FIG. 16).

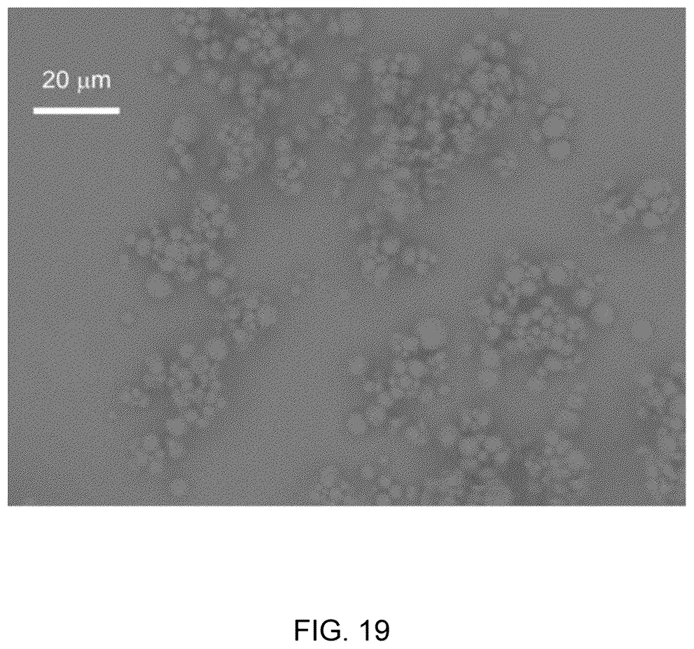

FIGS. 19, 20, and 21 present SEM images of artificial insoluble PMMA sacrificial fugitive materials. These representative scanning electron microscope cross section images are for PMMA particles with a D₅₀ of 5 μm. It is clear that these particles have a large heterogeneous distribution in particle sizes from the manufacturing process. However, the particles had D₅₀ particle sizes of 5, 12, and 20 μm respectively.

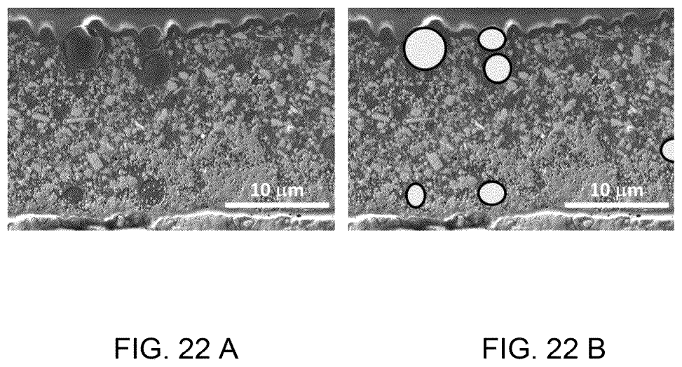

FIG. 22 A shows a representative scanning electron microscope cross section image for the electrode made with 10 wt % artificial insoluble PMMA sacrificial fugitive material that has a 5 μm D₅₀ particle size cured at 350° C. in argon for 60 minutes. FIG. 22 B shows the same SEM micrograph but the resulting pores from the insoluble PMMA are highlighted in the grey circles. The distribution in pore sizes is consistent with the heterogeneity presented in FIG. 19. The resulting pores are contained throughout the electrode.

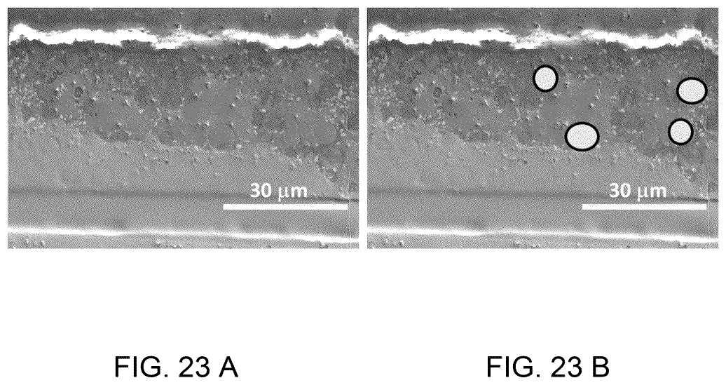

FIG. 23 A shows a representative scanning electron microscope cross section image for the electrode made with 30 wt % artificial insoluble PMMA sacrificial fugitive material that has a 5 μm D₅₀ particle size cured at 350° C. in argon for 60 minutes. FIG. 23 B shows the same SEM micrograph but the resulting pores from the insoluble PMMA are highlighted in the black circles. The distribution in pore sizes is consistent with the heterogeneity presented in FIG. 19. The resulting pores are contained throughout the electrode. The bottom is the copper current collector. The grey is the silicon particles. Top is the air side of the electrode.

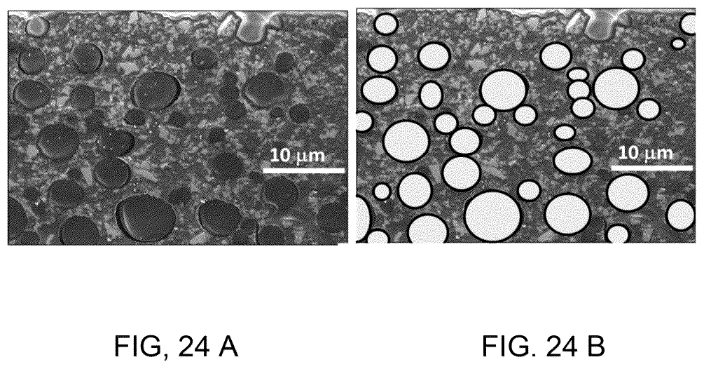

FIG. 24 A shows a representative scanning electron microscope cross section image for the electrode made with 45 wt % artificial insoluble PMMA sacrificial fugitive material that has a 5 μm D₅₀ particle size cured at 350° C. in argon for 60 minutes. FIG. 24 B shows the same SEM micrograph but the resulting pores from the insoluble PMMA are highlighted in the black circles. The distribution in pore sizes is consistent with the heterogeneity presented in FIG. 19. The resulting pores are contained throughout the electrode. The bottom is the copper current collector. The grey is the silicon particles. The top is the air side of the electrode.

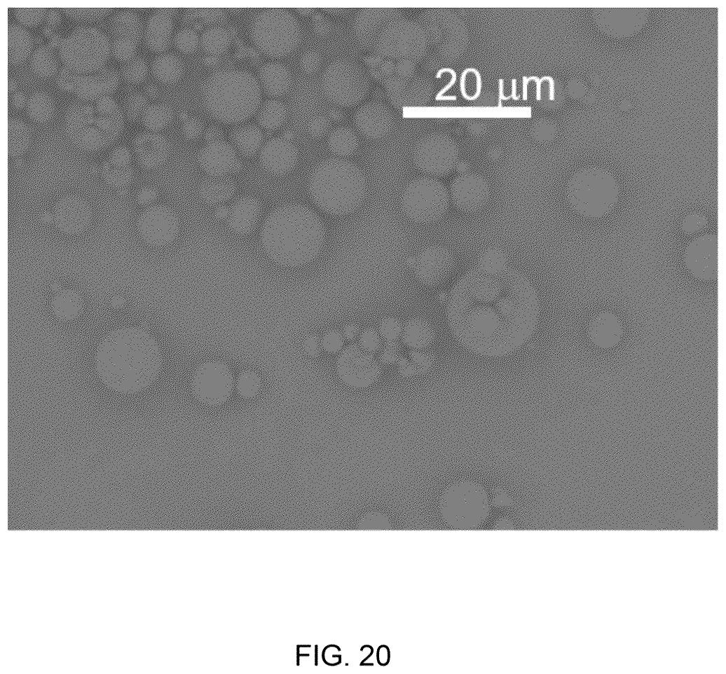

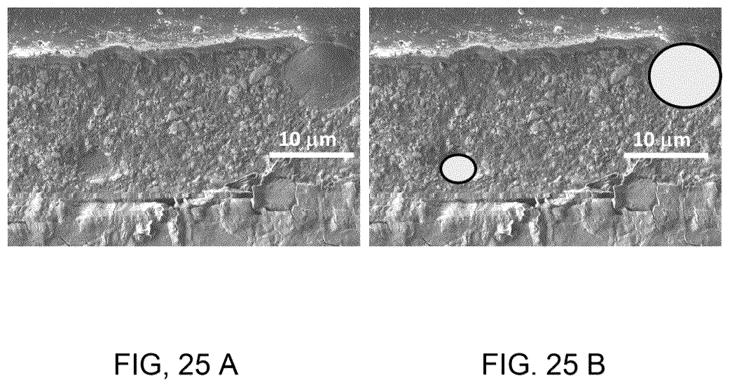

FIG. 25 A shows a representative scanning electron microscope cross section image for the electrode made with 10 wt % artificial insoluble PMMA sacrificial fugitive material that has a 12 μm D₅₀ particle size cured at 350° C. in argon for 60 minutes. FIG. 25 B shows the same SEM micrograph but the resulting pores from the insoluble PMMA are highlighted in the black circles. The distribution in pore sizes is consistent with the heterogeneity presented in FIG. 20. The resulting pores are contained throughout the electrode. The bottom is the copper current collector. The grey is the silicon particles. The top is the air side of the electrode.

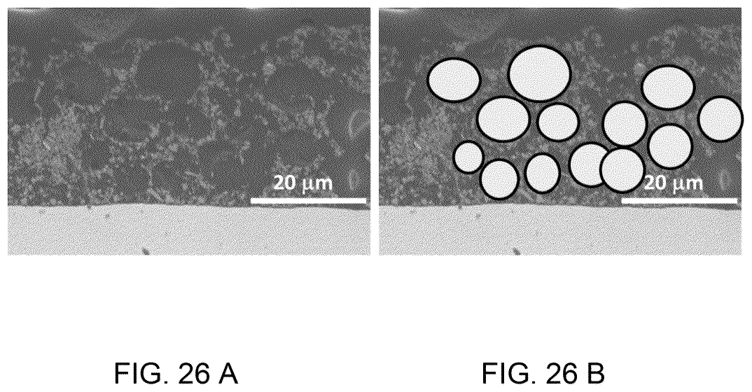

FIG. 26 A shows a representative scanning electron microscope cross section image for the electrode made with 45 wt % artificial insoluble PMMA sacrificial fugitive material that has a 12 μm D₅₀ particle size cured at 350° C. in argon for 60 minutes. FIG. 26 B shows the same SEM micrograph but the resulting pores from the insoluble PMMA are highlighted in the black circles. The distribution in pore sizes is consistent with the heterogeneity presented in FIG. 20. The resulting pores are contained throughout the electrode. The bottom is the copper current collector. The grey is the silicon particles. The top is the air side of the electrode.

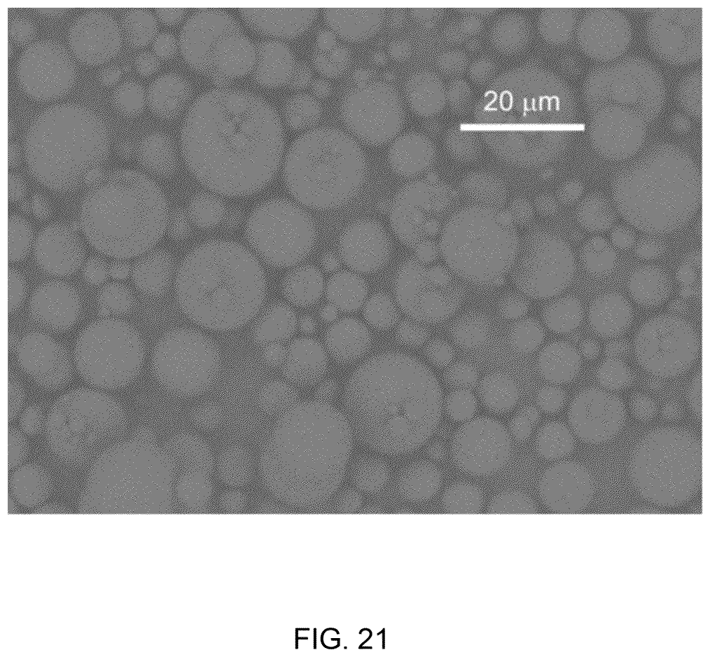

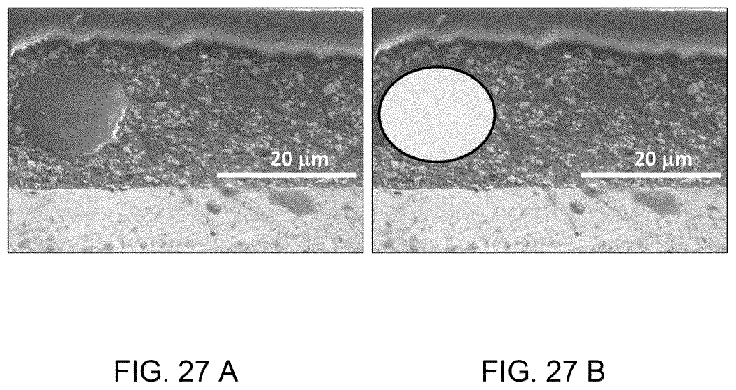

FIG. 27 A shows a representative scanning electron microscope cross section image for the electrode made with 10 wt % artificial insoluble PMMA sacrificial fugitive material that has a 20 μm D₅₀ particle size cured at 350° C. in argon for 60 minutes. FIG. 27 B shows the same SEM micrograph but the resulting pores from the insoluble PMMA are highlighted in the grey circles. The distribution in pore sizes is consistent with the heterogeneity presented in FIG. 21. The resulting pores are contained throughout the electrode. The bottom is the copper current collector. The grey is the silicon particles. The top is the air side of the electrode.

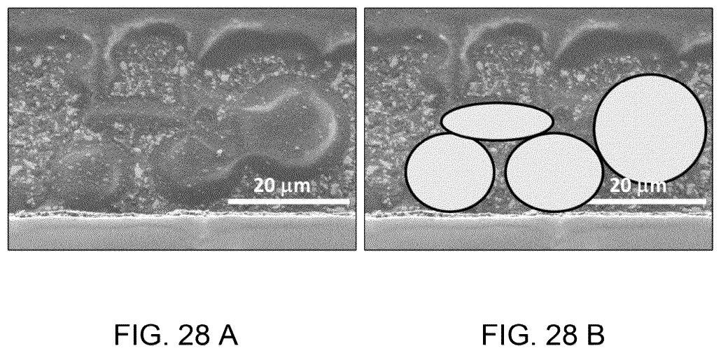

FIG. 28 A shows a representative scanning electron microscope cross section image for the electrode made with 30 wt % artificial insoluble PMMA sacrificial fugitive material that has a 20 μm D₅₀ particle size cured at 350° C. in argon for 60 minutes. FIG. 28 B shows the same SEM micrograph but the resulting pores from the insoluble PMMA are highlighted in the black circles. The distribution in pore sizes is consistent with the heterogeneity presented in FIG. 21. The resulting pores are contained throughout the electrode. The bottom is the copper current collector. The grey is the silicon particles. The top is the air side of the electrode.

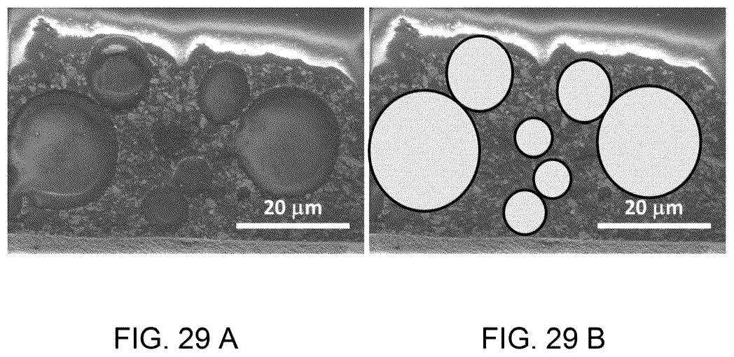

FIG. 29 A shows a representative scanning electron microscope cross section image for the electrode made with 45 wt % artificial insoluble PMMA sacrificial fugitive material that has a 20 μm D₅₀ particle size cured at 350° C. in argon for 60 minutes. FIG. 29 B shows the same SEM micrograph but the resulting pores from the insoluble PMMA are highlighted in the black circles. The distribution in pore sizes is consistent with the heterogeneity presented in FIG. 21. The resulting pores are contained throughout the electrode.

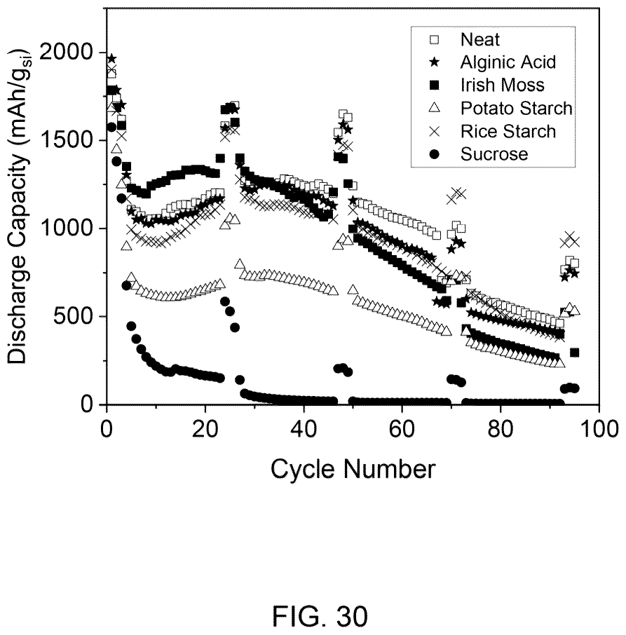

The resulting electrodes were incorporated into a half cell configuration battery (lithium metal counter electrode) and cycled a rate of C/3 (three hour discharge/charge) for 3 cycles, then 20 cycles at 1C (1 hour charge/discharge). This process was repeated 4 times. The loss in capacity at higher cycle numbers is due to passivation of the lithium metal counter electrode. Electrode performance for three sets of batteries is shown in FIG. 30 for the insoluble naturally derived sacrificial fugitive materials. FIG. 30 is a plot of electrochemical discharge capacity (mAh/gₛᵢ) as a function of cycle data measured for natural derived sacrificial fugitive materials and neat silicon electrode. Data were measured at 23° C. with loadings of 4 mA/cm² silicon. Data were measured at a rate of C/3 for three cycles, 1C for 20 cycles and repeated. Cells were cycled in a half cell configuration with Li metal as the counter electrode and 1.2 M LiPF₆ in 3:7 wt % ethylene carbonate:ethyl methyl carbonate. Decay in capacity at higher cycle numbers is due to lithium passivation from the large amount of lithium shuttled per cycle. The data clearly demonstrates performance variations depending on the insoluble naturally derived sacrificial fugitive material. However, Rice Starch and alginic acid rival neat silicon despite the higher areal loading.

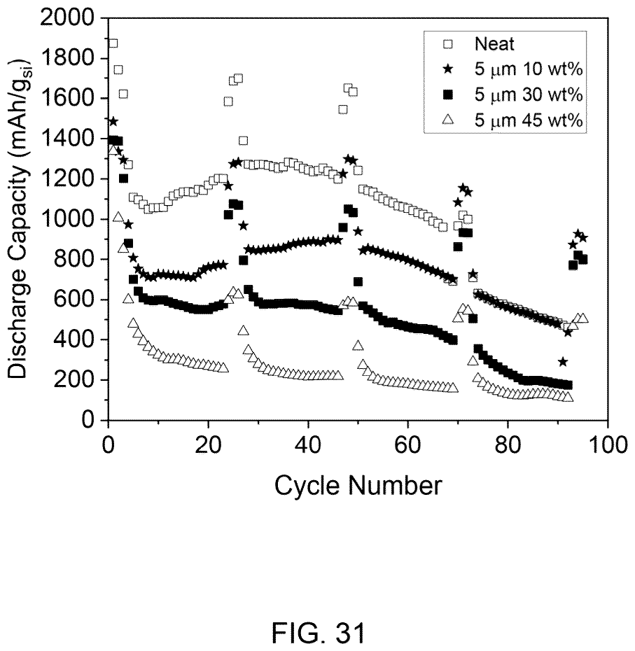

The electrochemical data for the electrodes formed with the artificial sacrificial fugitive material PMMA are presented in FIGS. 31, 32, 33, and 34. FIG. 31 presents the data for the 5 μm D₅₀ sacrificial fugitive material with 10, 30, and 45% sacrificial fugitive material added to the slurry. Data were measured at 23° C. with loadings of 4 mA/cm² silicon. Data were measured at a rate of C/3 for three cycles, 1C for 20 cycles and repeated. Cells were cycled in a half cell configuration with Li metal as the counter electrode and 1.2M LiPF₆ in 3:7 wt % ethylene carbonate:ethyl methyl carbonate. Decay in capacity at higher cycle numbers is due to lithium passivation from the large amount of lithium shuttled per cycle.

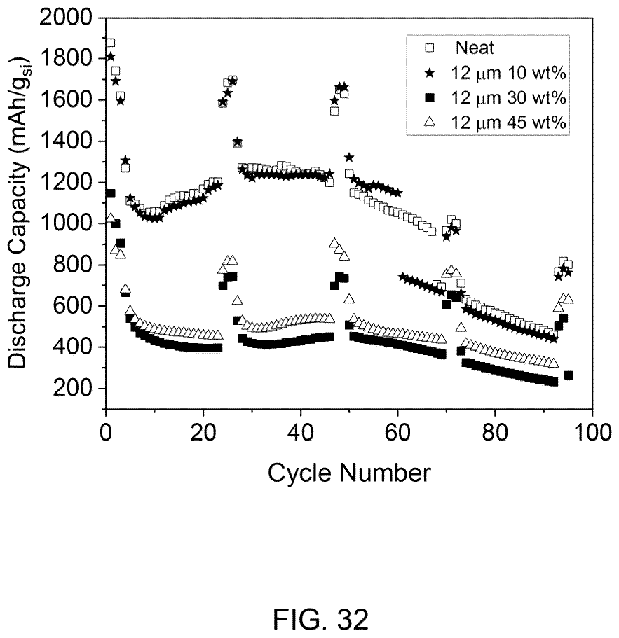

FIG. 32 presents the data for the 12 μm D₅₀ sacrificial fugitive material with 10, 30, and 45% sacrificial fugitive material added to the slurry. FIG. 32 shows the electrochemical discharge capacity (mAh/gₛᵢ) as a function of cycle data measured for 12 μm PMMA (D₅₀) sacrificial fugitive material at 10, 30, and 45 wt % additive along with neat silicon electrode. Data were measured at 23° C. with loadings of 4 mA/cm² silicon. Data were measured at a rate of C/3 for three cycles, 1C for 20 cycles and repeated. Cells were cycled in a half cell configuration with Li metal as the counter electrode and 1.2M LiPF₆ in 3:7 wt % ethylene carbonate:ethyl methyl carbonate. Decay in capacity at higher cycle numbers is due to lithium passivation from the large amount of lithium shuttled per cycle.

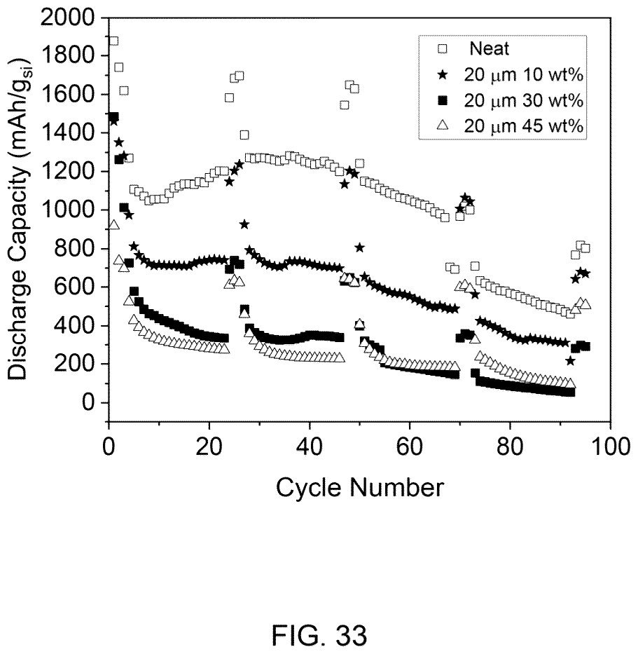

FIG. 33 presents the data for the 20 μm D₅₀ sacrificial fugitive material with 10, 30, and 45% sacrificial fugitive material added to the slurry. FIG. 33 shows the electrochemical discharge capacity (mAh/gₛᵢ) as a function of cycle data measured for 20 μm PMMA (D₅₀) sacrificial fugitive materials at 10, 30, and 45 wt % additive along with neat silicon electrode. Data were measured at 23° C. with loadings of 4 mA/cm² silicon. Data were measured at a rate of C/3 for three cycles, 1C for 20 cycles and repeated. Cells were cycled in a half cell configuration with Li metal as the counter electrode and 1.2M LiPF₆ in 3:7 wt % ethylene carbonate:ethyl methyl carbonate. Decay in capacity at higher cycle numbers is due to lithium passivation from the large amount of lithium shuttled per cycle.

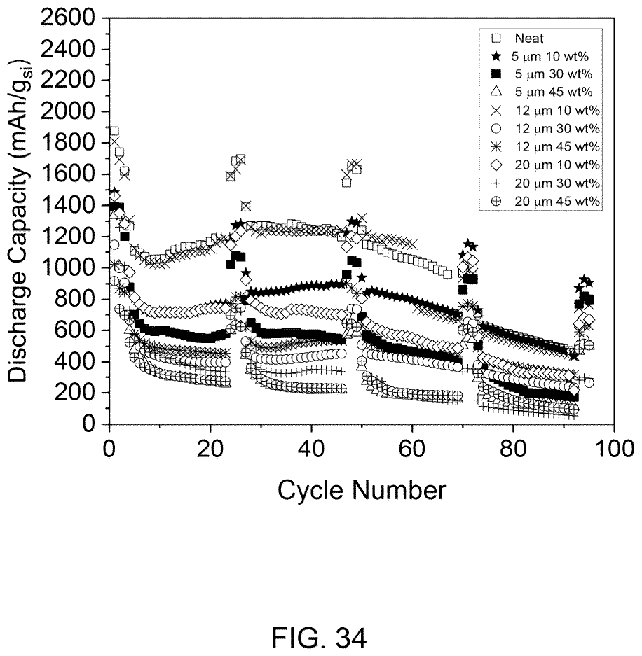

FIG. 34 compares all the PMMA samples on the same plot. The data clearly show differences in behavior consistent with different electrode architectures with the 12 μm D₅₀ particles exhibiting the best performance rivaling the thinner neat silicon electrode. FIG. 34 shows the cumulative electrochemical discharge capacity (mAh/gₛᵢ) as a function of cycle data measured for 5, 12, and 20 PMMA (D₅₀) sacrificial fugitive materials at 10, 30, and 45 wt % additive along with neat silicon electrode. Data were measured at 23° C. with loadings of 4 mA/cm² silicon. Data were measured at a rate of C/3 for three cycles, 1C for 20 cycles and repeated. Cells were cycled in a half cell configuration with Li metal as the counter electrode and 1.2M LiPF₆ in 3:7 wt % ethylene carbonate:ethyl methyl carbonate. Decay in capacity at higher cycle numbers is due to lithium passivation from the large amount of lithium shuttled per cycle.

From the above SEM data it is clear the addition of the insoluble sacrificial fugitive material and subsequent thermal decomposition in argon produces clear inclusions of pores within the electrodes. Further, the insoluble sacrificial fugitive material has a dramatic result on electrochemical cycling. The porosity of the electrodes was estimated using the Rule of Mixtures (theoretical and measured densities) and a micrometer to measure the thickness.

Tortuosity of the electrode is a key parameter. Tortuosity in this work is a critical parameter related to the transport of lithium ions and liquid electrolyte within the electrode. For this work tortuosity is best demonstrated with reference to FIG. 3 where a highly tortuous path (t>>>1) generates a complex pathway for lithium ions and or battery electrolyte to diffuse. Conversely a low tortuosity pathway (t=1) is a direct path for ions and liquid electrolyte to diffuse. This tortuosity value is a ratio of diffusivity in the confined space (electrode) versus a bulk liquid electrolyte.

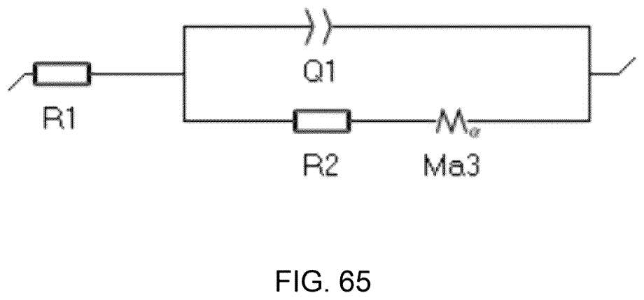

Electrochemical Impedance Spectroscopy (EIS) was used to determine the tortuosity of the electrodes in coin cell configuration which allows for quick testing of porous electrodes using a block a blocking electrolyte. The blocking electrolyte solution was 10 mMol tertbutyl-ammonium hexafluorophosphate (TBAPF₆, Sigma-Aldrich) in 1:1 (w/w) ethylene carbonate (EC, Sigma-Aldrich) to dimethyl carbonate (DMC, Sigma-Aldrich). A symmetric cell with only 15 mm copper current collector, 19 mm Celgard 2325 separator, and 120 μL electrolyte solution was made to provide a good high frequency intercept reference and account for the resistance from the separator. A symmetric cell was used to ensure the EIS measurement estimated the impedance from the electrode. The EIS measurement (SP-200, Biologic) was taken at room temperature from 1 MHz to 100 kHz to achieve a detailed spectrum in the high frequency region. FIG. 65 shows the transmission line model (R1+Q1/(R2+Ma3), Biologic) used to fit the measured spectra and calculate the corresponding MacMullin number (Nm).

The tortuosity can then be determined from the ratio of the MacMullin number to porosity shown in equation 1.

$${N}_{m} = \frac{τ}{ε} = \frac{{R}_{ion} \times A \times k}{d} \qquad ( 1 )$$

Where τ is tortuosity, ε is porosity, Rᵢₒₙ is the ionic resistance of the electrolyte, A is the area of the electrode, k is the estimated conductivity of the electrolyte, and d is the thickness of the electrode. The electrode porosity was calculated based on equation 2.

$$Porosity = ( 1 - \frac{{ρ}_{measured}}{{ρ}_{theoretical}} ) \qquad ( 2 )$$

Where the ρ_{measured} is the measured density and ρ_{theoretical} is the theoretical density. The μ_{measured} was calculated based on equation 3.

$${ρ}_{measured} = \frac{{m}_{electrode} - {m}_{Cu}}{tA} \qquad ( 3 )$$

Mass of the electrode m_{electrode} is subtracted from the mass of the copper current collector m_{Cu} which is divided by the thickness of the electrode t and area of the electrode A. The measured density was measured on a sacrificial electrode of the same mass loading as to not destroy the architecture of the silicon composite electrode with the micrometer. The theoretical density, ρ_{theoretical}, was based on the rule of mixtures where the density of the individual components is used to estimate the composite's density, shown in equation 4.

$${ρ}_{theoretical} = \frac{1}{\frac{0.8}{{ρ}_{Si}} + \frac{0.1}{{ρ}_{C 45}} + \frac{0.1}{{ρ}_{P 84}}} \qquad ( 4 )$$

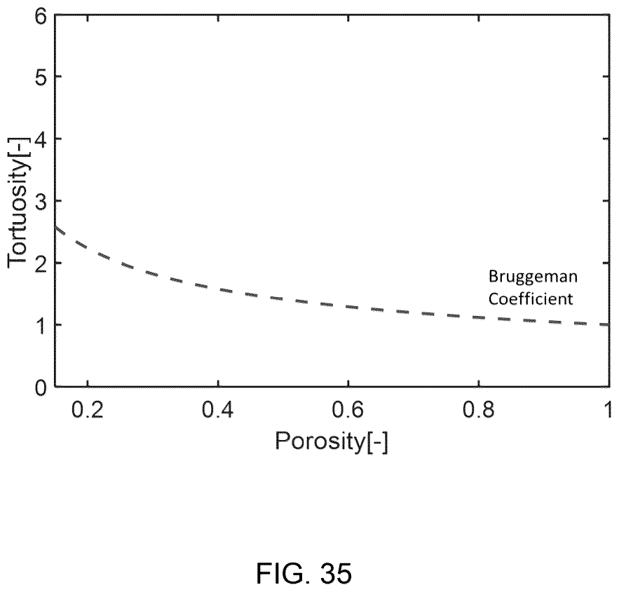

FIG. 35 presents a theoretical tortuosity and porosity plot of the Bruggeman Coefficient. This plot is related to free-space transport impacted (tortuosity) by the geometry of the pores. A theoretical tortuosity of 1 and a porosity of 1 (or 100%) has no resistance to transport.

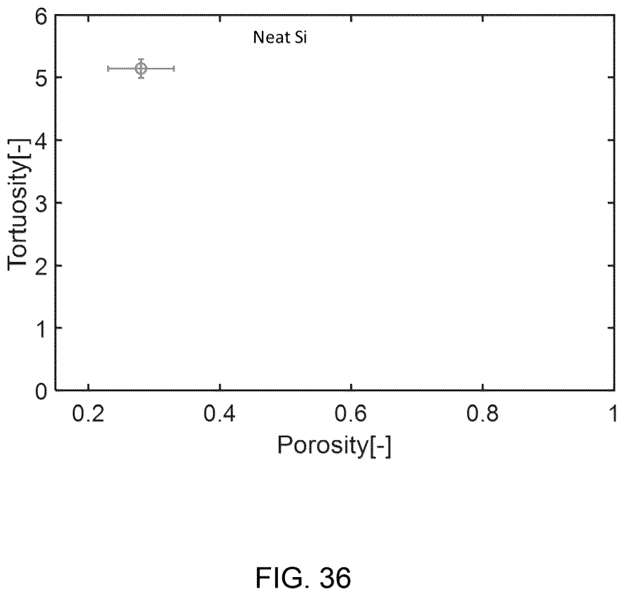

From the EIS data above and porosity data above an experimentally measured tortuosity and porosity of the neat 2.3 mA/cm² electrode is presented in FIG. 36 revealing a tortuosity of 5.14 and a porosity of 28%. This electrode is highly tortuous and low porosity.

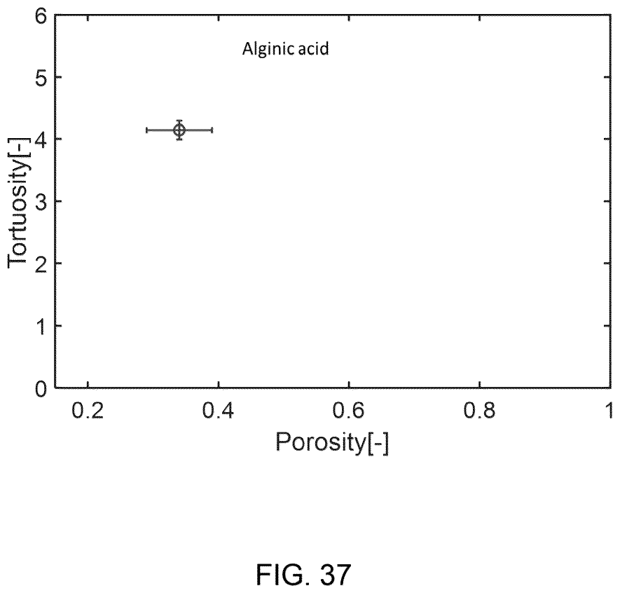

FIG. 37 shows experimentally measured tortuosity and porosity for a 4 mA/cm² electrode made with alginic acid sacrificial fugitive material with a D₅₀ via light scattering of 9.6 μm after curing for 60 minutes at 350° C. in argon. Cast had 10 wt % sacrificial fugitive material prior to thermal decomposition with a target loading of 80 wt % silicon. The resulting tortuosity was 4.14 (versus 5.14 for the neat) and a porosity of 34% (versus 28% for the neat).

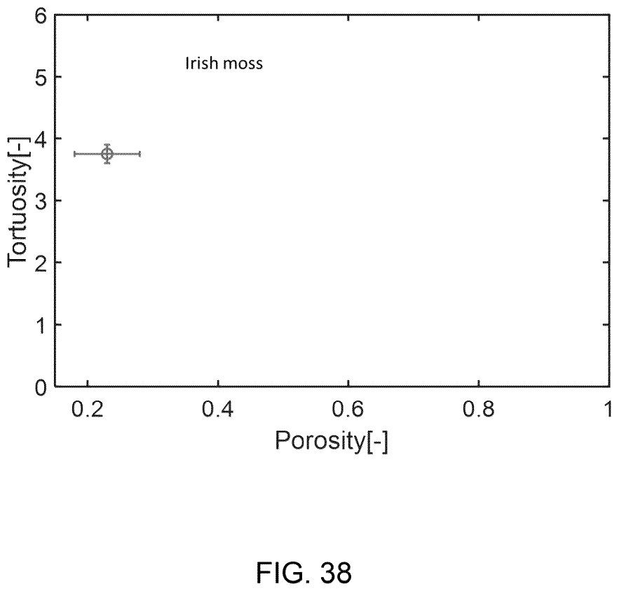

FIG. 38 shows experimentally measured tortuosity and porosity for a 4 mA/cm² electrode made with Irish Moss sacrificial fugitive material with a D₅₀ via light scattering of 12.8 μm after curing for 60 minutes at 350° C. in argon. Cast had 10 wt % sacrificial fugitive material prior to thermal decomposition with a target loading of 80 wt % silicon. The resulting tortuosity was 3.75 (versus 5.14 for the neat) and a porosity of 23% (versus 28% for the neat).

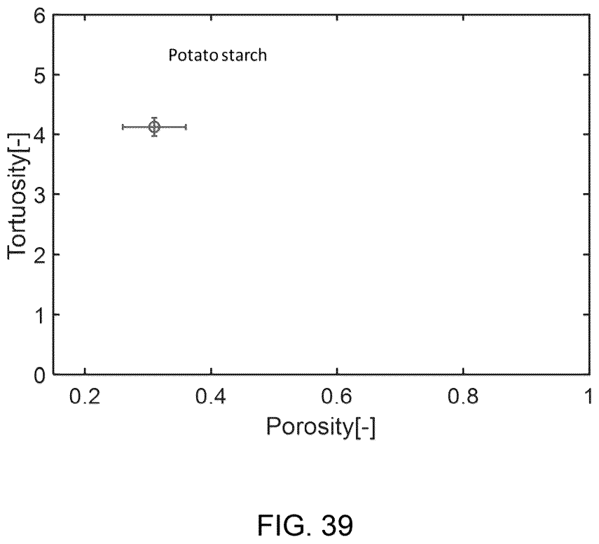

FIG. 39 shows experimentally measured tortuosity and porosity for a 4 mA/cm² electrode made with potato starch sacrificial fugitive material with a D₅₀ via light scattering of 15.2 μm after curing for 60 minutes at 350° C. in argon. Cast had 10 wt % sacrificial fugitive material prior to thermal decomposition with a target loading of 80 wt % silicon. The resulting tortuosity was 4.11 (versus 5.14 for the neat) and a porosity of 31% (versus 28% for the neat).

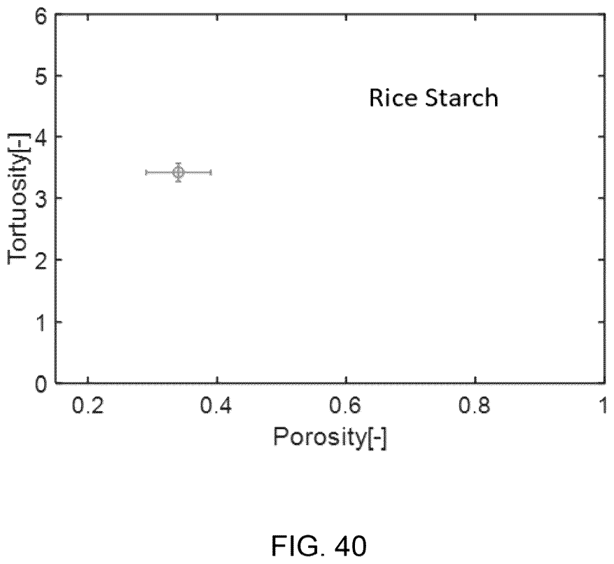

FIG. 40 shows the experimentally measured tortuosity and porosity for a 4 mA/cm² electrode made with rice starch sacrificial fugitive material with a D₅₀ via light scattering of 0.7 μm after curing for 60 minutes at 350° C. in argon. Cast had 10 wt % pore sacrificial fugitive material prior to thermal decomposition with a target loading of 80 wt % silicon. The resulting tortuosity was 3.42 (versus 5.14 for the neat) and a porosity of 31% (versus 28% for the neat).

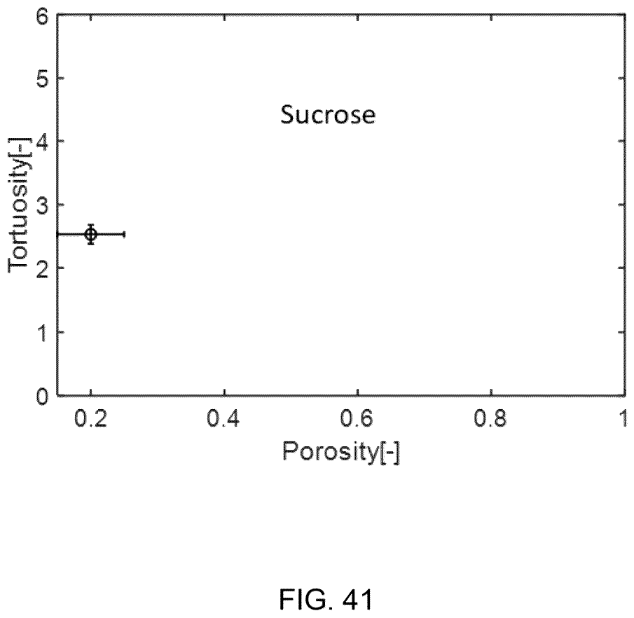

FIG. 41 shows experimentally measured tortuosity and porosity for a 4 mA/cm² electrode made with sucrose sacrificial fugitive material with a D₅₀ via light scattering of 35.7 μm after curing for 60 minutes at 350° C. in argon. Cast had 10 wt % sacrificial fugitive material prior to thermal decomposition with a target loading of 80 wt % silicon. The resulting tortuosity was 2.52 (versus 5.14 for the neat) and a porosity of 20% (versus 28% for the neat).

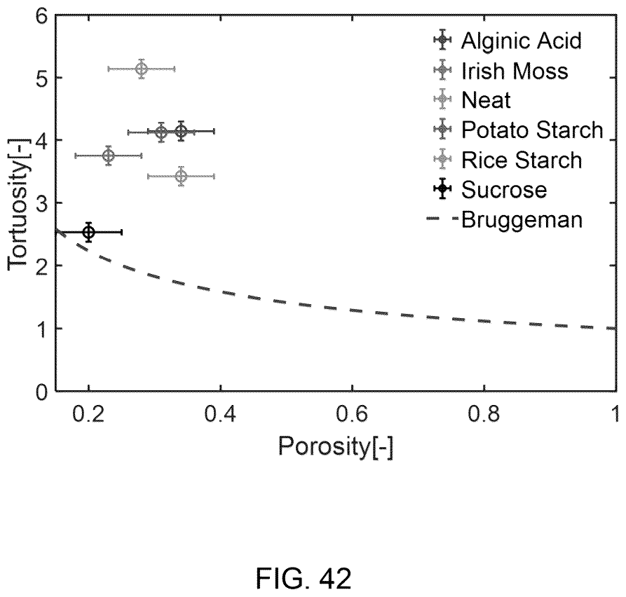

FIG. 42 shows a comparison of the porosity and tortuosity data measured for the samples cured at 350° C. and derived from natural insoluble sacrificial fugitive materials. From the data it is clear that the addition of the sacrificial fugitive material has a significant effect on the resulting porosity and tortuosity of the electrodes resulting in significantly lower tortuosity. This lower tortuosity and changes in porosity is directly related with the subject invention and the formation of a more ideal diffusion process imaged in the SEM data sets (FIGS. 17 and 18).

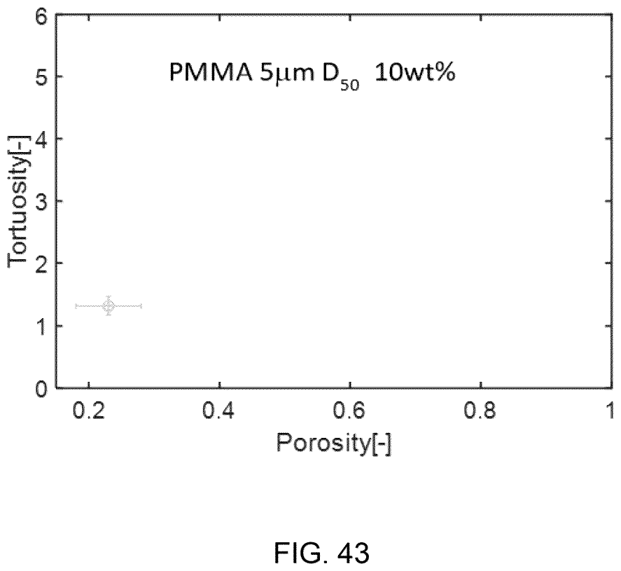

FIG. 43 shows the experimentally measured tortuosity and porosity for a 4 mA/cm² electrode made with synthetic PMMA sacrificial fugitive material with a D₅₀ via light scattering of 5 μm after curing for 60 minutes at 350° C. in argon. Cast had 10 wt % sacrificial fugitive material prior to thermal decomposition with a target loading of 80 wt % silicon. The resulting tortuosity was 1.33 (versus 5.14 for the neat) and a porosity of 20% (versus 28% for the neat).

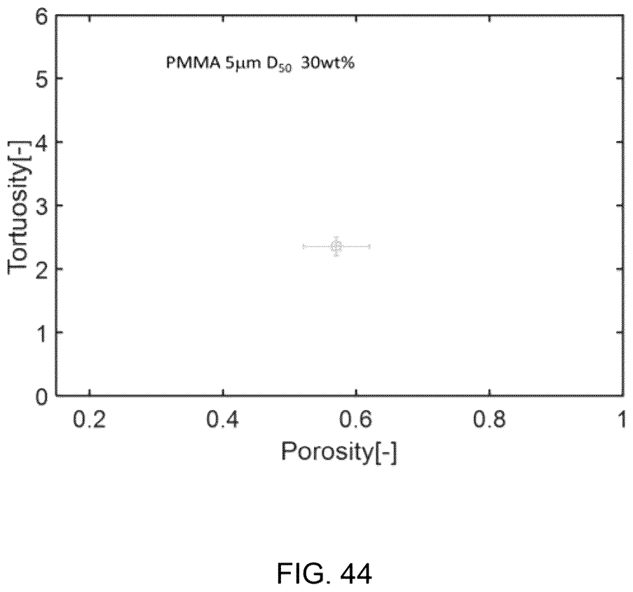

FIG. 44 shows the experimentally measured tortuosity and porosity for a 4 mA/cm² electrode made with synthetic PMMA sacrificial fugitive material with a D₅₀ via light scattering of 5 μm after curing for 60 minutes at 350° C. in argon. Cast had 30 wt % sacrificial fugitive material prior to thermal decomposition with a target loading of 80 wt % silicon. The resulting tortuosity was 2.36 (versus 5.14 for the neat) and a porosity of 47% (versus 28% for the neat).

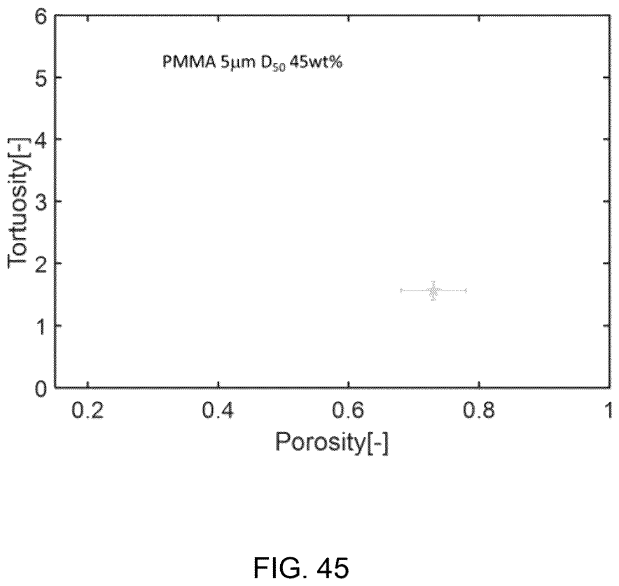

FIG. 45 shows the experimentally measured tortuosity and porosity for a 4 mA/cm² electrode made with synthetic PMMA sacrificial fugitive material with a D₅₀ via light scattering of 5 μm after curing for 60 minutes at 350° C. in argon. Cast had 45 wt % sacrificial fugitive material prior to thermal decomposition with a target loading of 80 wt % silicon. The resulting tortuosity was 1.57 (versus 5.14 for the neat) and a porosity of 73% (versus 28% for the neat).

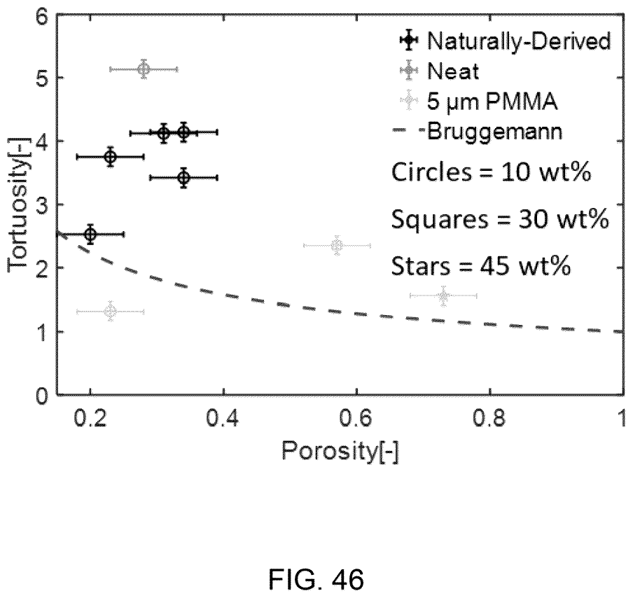

FIG. 46 compares the porosity and tortuosity data from the D₅₀ via light scattering of 5 μm insoluble sacrificial fugitive PMMA particles after curing for 60 minutes at 350° C. in argon with various loadings of sacrificial fugitive material.

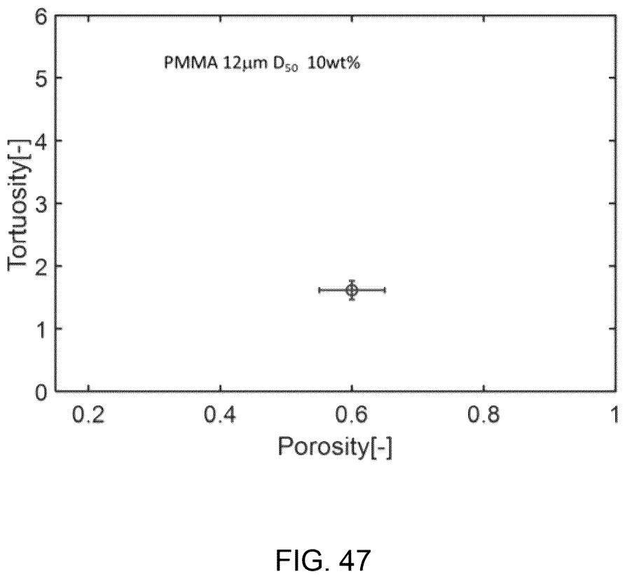

FIG. 47 show experimentally measured tortuosity and porosity for a 4 mA/cm² electrode made with synthetic PMMA sacrificial fugitive material with a D₅₀ via light scattering of 12 μm after curing for 60 minutes at 350° C. in argon. Cast had 10 wt % sacrificial fugitive material prior to thermal decomposition with a target loading of 80 wt % silicon. The resulting tortuosity was 1.62 (versus 5.14 for the neat) and a porosity of 60% (versus 28% for the neat).

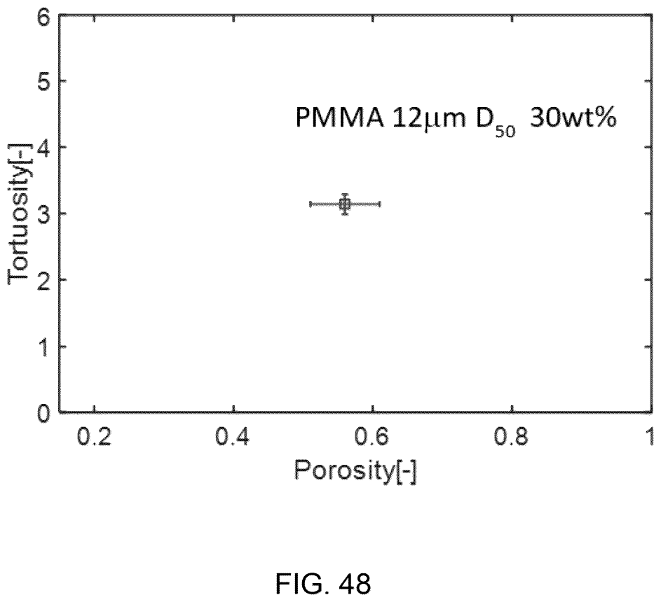

FIG. 48 show experimentally measured tortuosity and porosity for a 4 mA/cm² electrode made with synthetic PMMA sacrificial fugitive material with a D₅₀ via light scattering of 12 μm after curing for 60 minutes at 350° C. in argon. Cast had 30 wt % sacrificial fugitive material prior to thermal decomposition with a target loading of 80 wt % silicon. The resulting tortuosity was 3.14 (versus 5.14 for the neat) and a porosity of 56% (versus 28% for the neat).

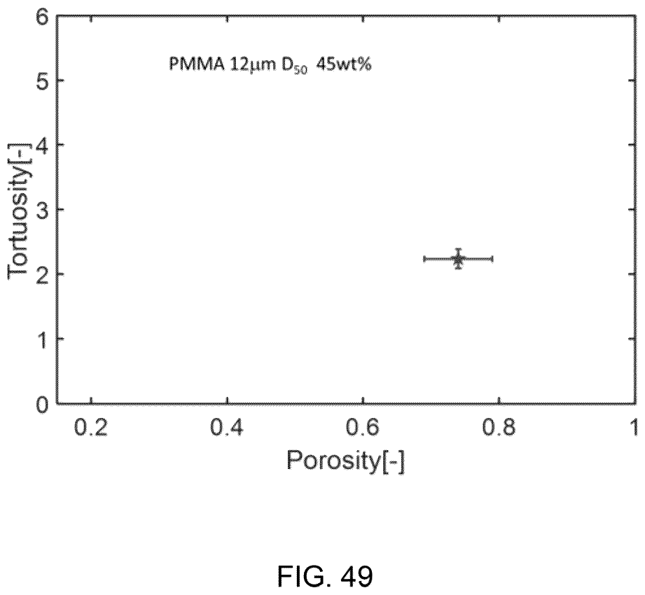

FIG. 49 show experimentally measured tortuosity and porosity for a 4 mA/cm² electrode made with synthetic PMMA sacrificial fugitive material with a D₅₀ via light scattering of 12 μm after curing for 60 minutes at 350° C. in argon. Cast had 45 wt % sacrificial fugitive material prior to thermal decomposition with a target loading of 80 wt % silicon. The resulting tortuosity was 2.24 (versus 5.14 for the neat) and a porosity of 74% (versus 28% for the neat).

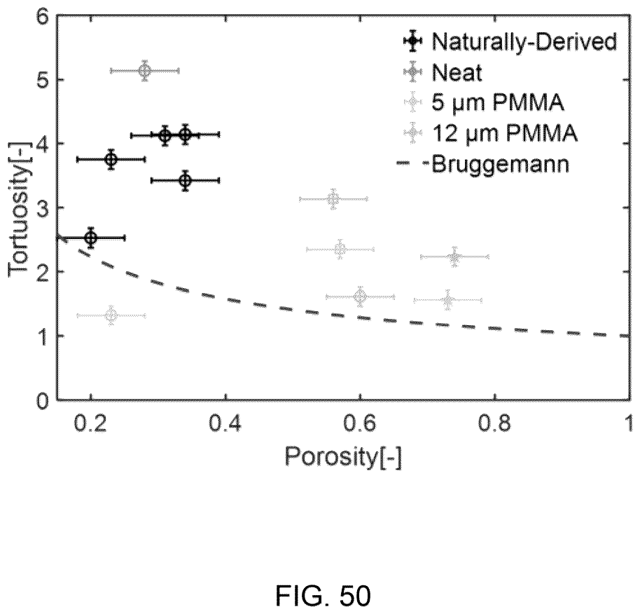

FIG. 50 compares the porosity and tortuosity data from the D₅₀ via light scattering of 12 μm insoluble sacrificial fugitive PMMA particles along with the 5 μm data, after curing for 60 minutes at 350° C. in argon.

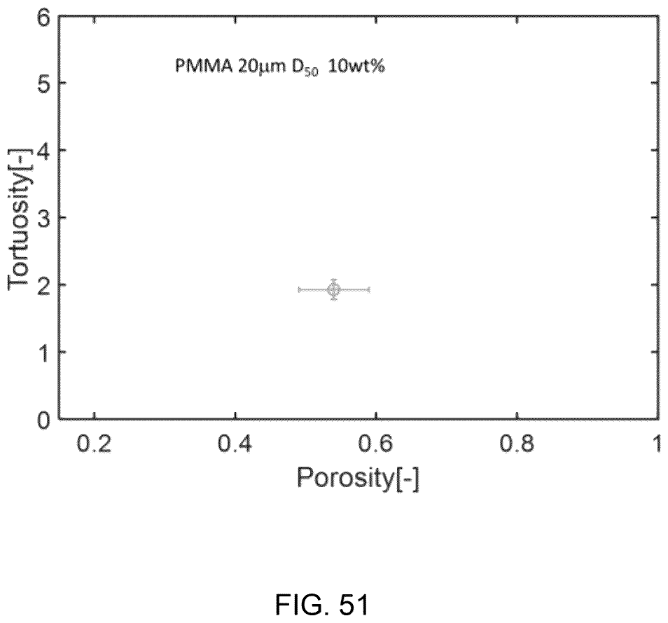

FIG. 51 shows experimentally measured tortuosity and porosity for a 4 mA/cm² electrode made with synthetic PMMA sacrificial fugitive material with a D₅₀ via light scattering of 20 μm after curing for 60 minutes at 350° C. in argon. Cast had 10 wt % sacrificial fugitive material prior to thermal decomposition with a target loading of 80 wt % silicon. The resulting tortuosity was 1.93 (versus 5.14 for the neat) and a porosity of 54% (versus 28% for the neat).

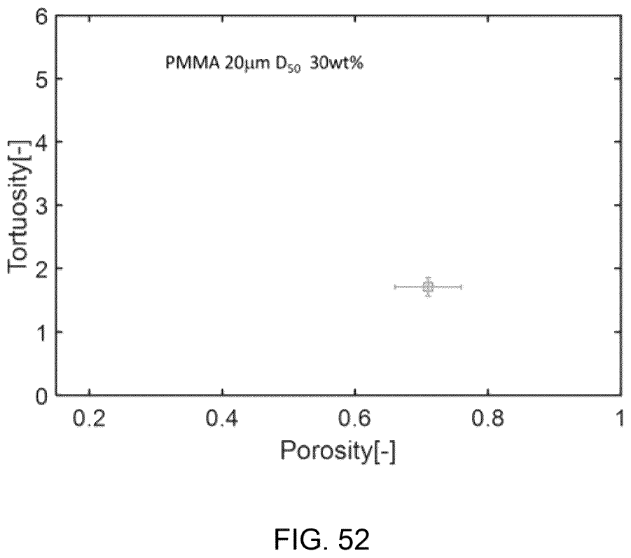

FIG. 52 shows experimentally measured tortuosity and porosity for a 4 mA/cm² electrode made with synthetic PMMA sacrificial fugitive material with a D₅₀ via light scattering of 20 μm after curing for 60 minutes at 350° C. in argon. Cast had 30 wt % sacrificial fugitive material prior to thermal decomposition with a target loading of 80 wt % silicon. The resulting tortuosity was 1.71 (versus 5.14 for the neat) and a porosity of 71% (versus 28% for the neat).

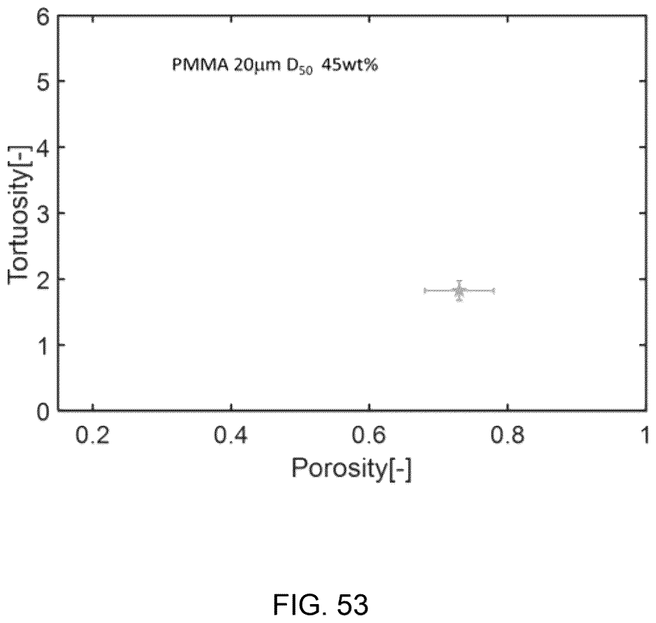

FIG. 53 show experimentally measured tortuosity and porosity for a 4 mA/cm² electrode made with synthetic PMMA sacrificial fugitive material with a D₅₀ via light scattering of 20 μm after curing for 60 minutes at 350° C. in argon. Cast had 45 wt % sacrificial fugitive material prior to thermal decomposition with a target loading of 80 wt % silicon. The resulting tortuosity was 1.83 (versus 5.14 for the neat) and a porosity of 73% (versus 28% for the neat).

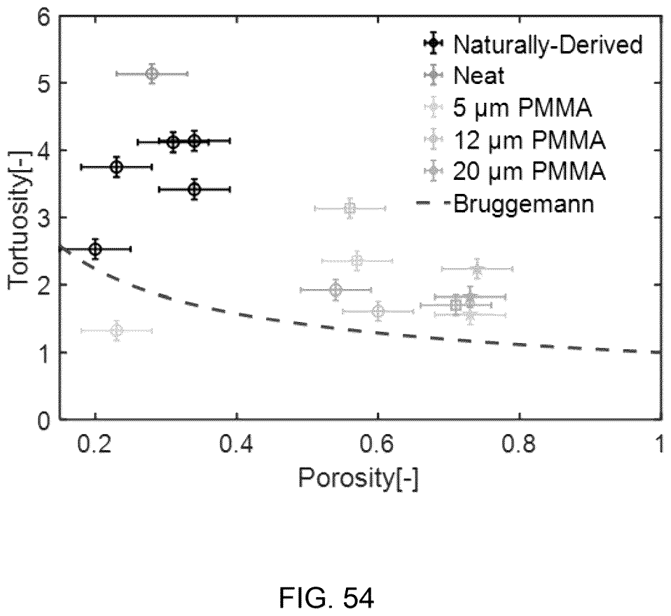

FIG. 54 compares the porosity and tortuosity data from the D₅₀ via light scattering of 20 μm insoluble sacrificial fugitive PMMA particles, along with the 5 and 12 μm data, after curing for 60 minutes at 350° C. in argon.

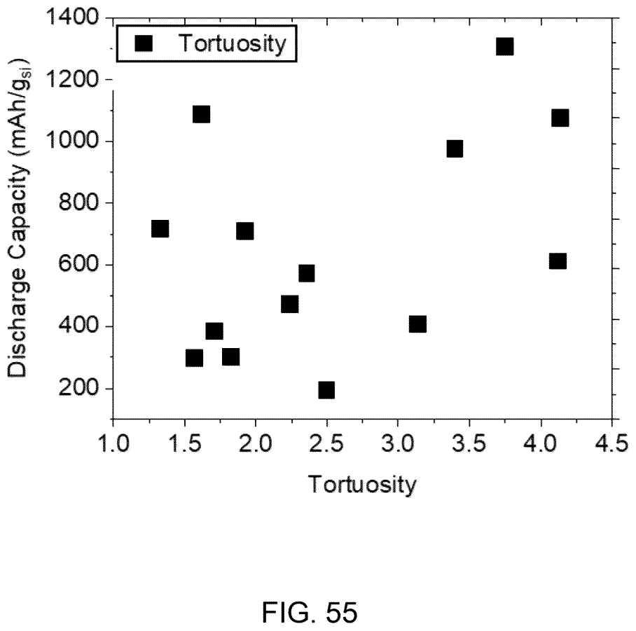

From the above data it is clear the addition of the insoluble sacrificial fugitive material has a dramatic effect on the resulting pore structure and dramatic decrease in tortuosity within the electrode. This will lead to an increase in ion transport rate and the ability to infiltrate materials within the electrode architecture. However, the effect on cycling performance is not intuitive. FIG. 55 shows a plot of discharge capacity (mAh/gₛᵢ) as measured on the 15^{th} cycle (1 C rate) before lithium passivation dominates the cycling performance at higher cycle numbers versus tortuosity. From this data it is clear that there is no correlation between tortuosity on the cell and performance.

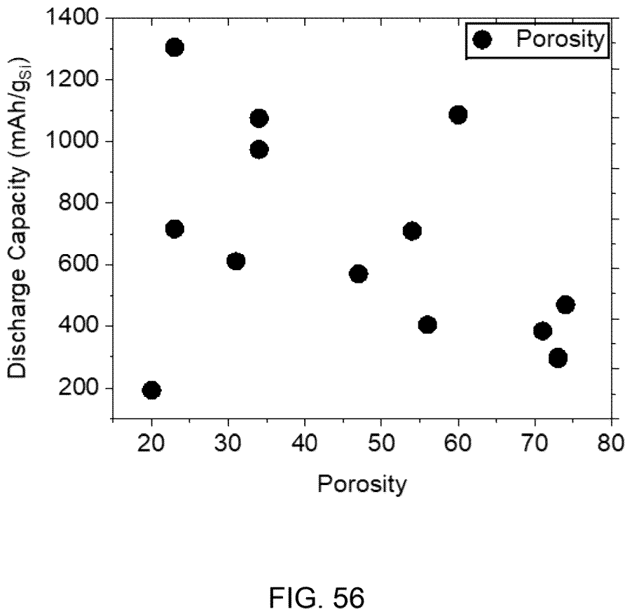

Similarly, FIG. 56 shows a plot of discharge capacity (mAh/gₛᵢ) as measured on the 15^{th} cycle (1C rate) before lithium passivation dominates the cycling performance at higher cycle numbers versus porosity. From this data it is clear that there is no correlation between porosity on the cell and performance.

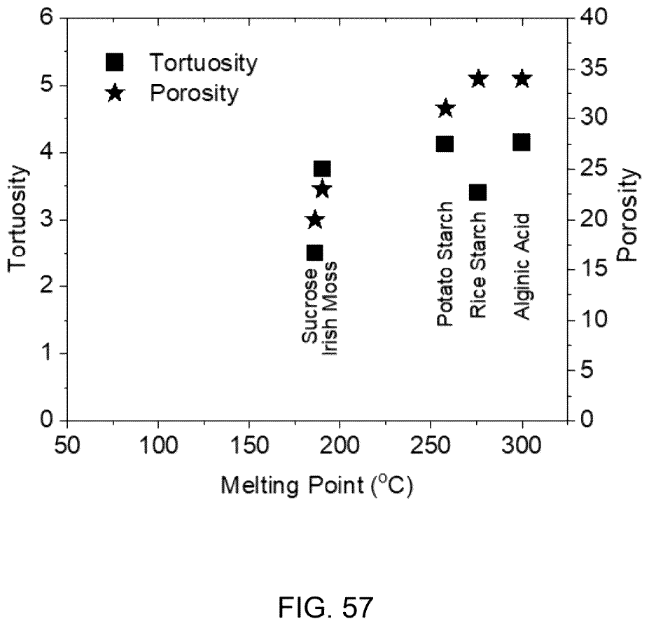

In contrast, the data shows a correlation with the melting point of the sacrificial fugitive materials. FIG. 57 is a plot of tortuosity (left) and porosity (right) as a function of natural sacrificial fugitive material melting point. FIG. 57 shows a plot of tortuosity and porosity versus melting point of the sacrificial fugitive materials revealing a surprising correlation where higher melting points lead to more porosity. This indicates that the melting point of the insoluble sacrificial fugitive material is essential to maintaining pore structure from the additive during thermal decomposition. Without a high decomposition temperature the architecture collapses or results in reorganization of the polymer binder within the pores from solvation and dissolution when heated.

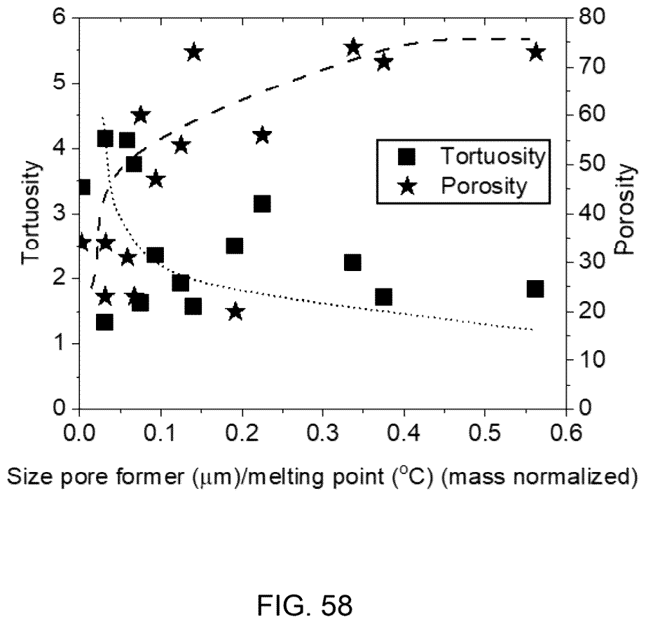

Further FIG. 58 demonstrates that this relation is further extended when incorporating the initial average insoluble sacrificial fugitive material particle size by light scattering as a function of melting point and mass of sacrificial fugitive material. FIG. 58 is a plot of tortuosity (left) and porosity (right) as a function of size of the sacrificial fugitive material (d₅₀)/melting point normalized to mass of sacrificial fugitive material added to electrode slurry. Dashed lines are added to aid viewing.

From this data it is clear that tortuosity and porosity depend highly on the particle size and melting point indicating one skilled in the art could dial in the pore structure and tortuosity of the resulting electrode through the incorporation of higher the melting point (resulting in a lower Size/melting point ratio) and the resulting lower tortuosity and porosity. Similarly, one could incorporate higher particle sizes and a much lower melting point and result in materials with very high porosities and very low tortuosity.

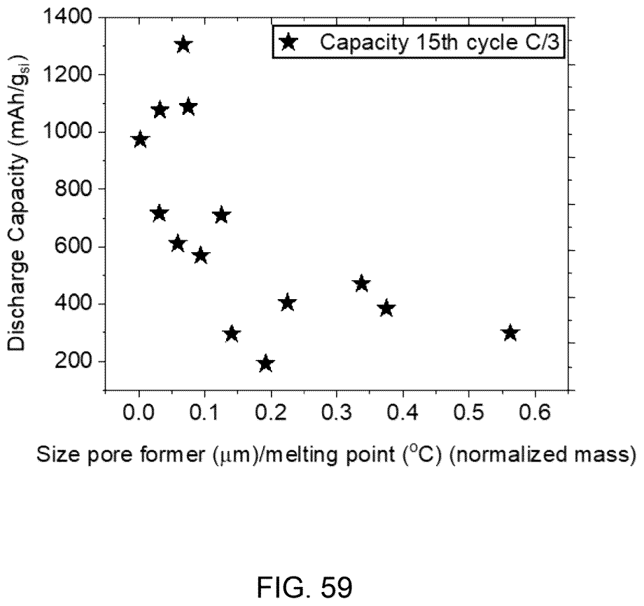

With regards to electrode performance normalizing the discharge capacity measured at 15 cycles (mAh/gₛᵢ) versus the insoluble sacrificial fugitive material size/melting point ratio, FIG. 59, reveals a clear correlation in electrode performance. FIG. 59 is a plot of discharge capacity (mAh/gₛᵢ) of the 15^{th} cycle (1 C rate) as a function of size of the sacrificial fugitive material (d₅₀)/melting point normalized to mass of sacrificial fugitive material added to electrode slurry. One skilled in the art would identify the need to reduce the size of the sacrificial fugitive material (such as rice starch (0.7 μm particle size) and alginic acid (9.6 μm particle size) and increase the melting point (rice starch melting point 276° C.; alginic acid melting point 300° C.) to obtain a better performing electrode through the rapid loss of the sacrificial fugitive material and preventing the reorganization of the binder and carbon within the electrode due to dissolution in liquified sacrificial fugitive material.

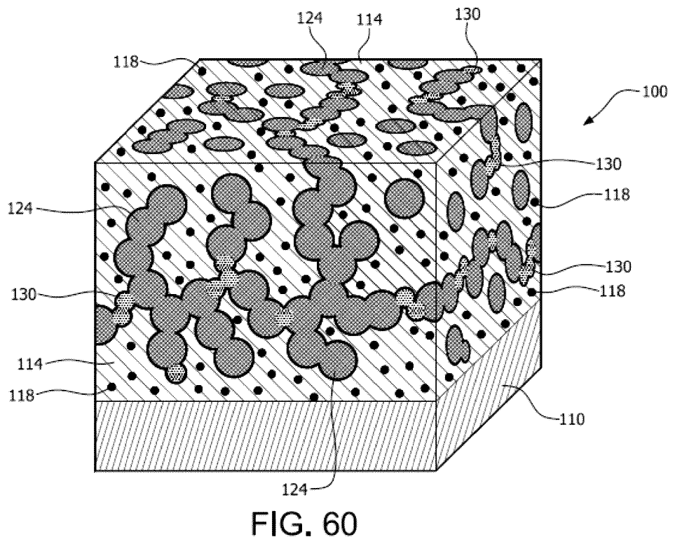

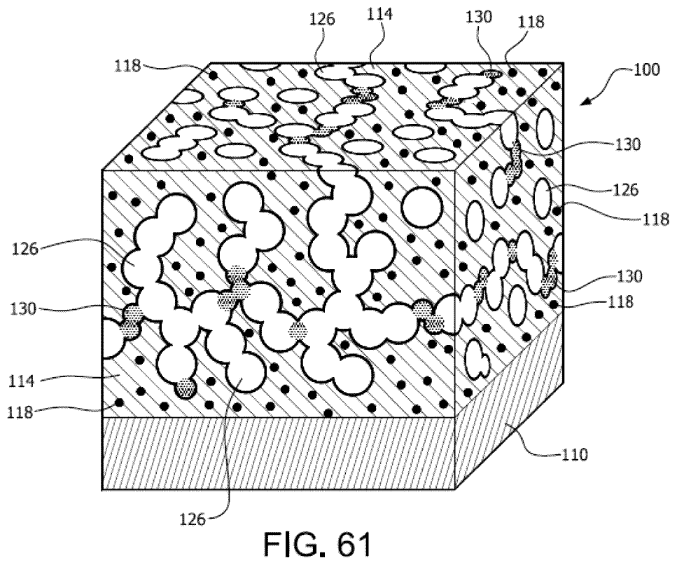

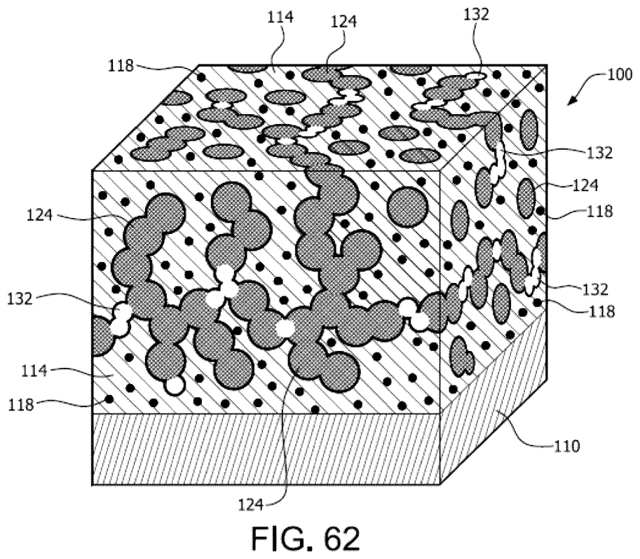

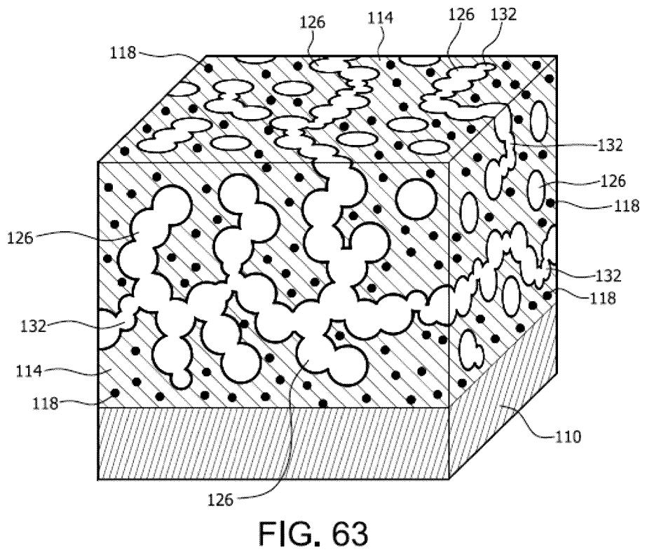

There is shown in FIGS. 60-63 an alternative method of making an electrode 100 which has a current collector 110, a redox active material 114, a conductive additive 118, and a sacrificial fugitive material 124. In this embodiment, there is a second sacrificial fugitive material 130. The second sacrificial fugitive material 130 has a particle size that is less than the particle size of the first sacrificial fugitive material 124, and the materials also have different thermal decomposition temperatures. The mixture is well mixed such that some particles of the first sacrificial material 124 are in contact with particles of the second sacrificial fugitive material 130. As the mixture is heated, the sacrificial fugitive material with the lower thermal decomposition temperature will be removed first. In FIG. 61 this is the first sacrificial fugitive material 124, which when removed leaves pores 126. In FIG. 62 the case is shown where the second sacrificial fugitive material 130 has a lower thermal decomposition temperature, and leaves pores 132. In either case, as the heating continues and the temperature rises the remaining sacrificial fugitive material will be removed, leaving the electrode with larger pores 126 communicating with smaller pores 132, as shown in FIG. 63.

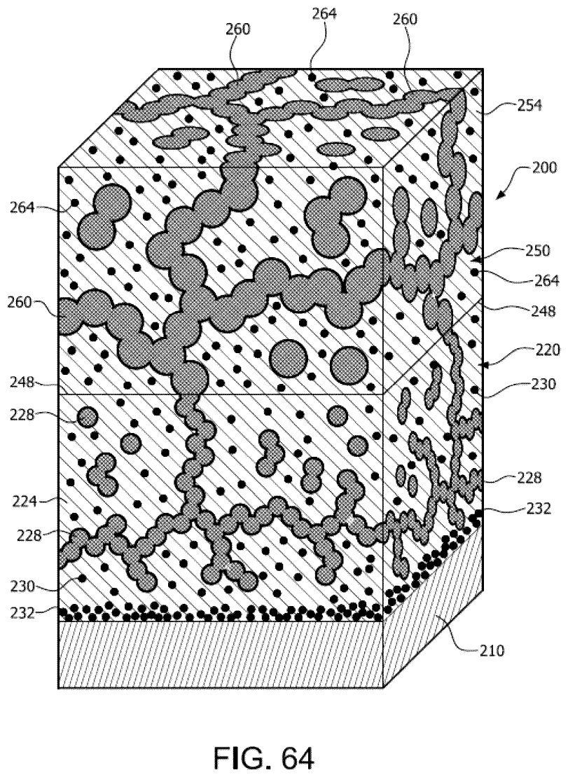

There is shown in FIG. 64 an embodiment in which more than one layer of the mixture is applied to form an electrode 200. The electrode 200 has a current collector 210. A first mixture 220 is applied to the current collector and has a first redox active material 224, a first sacrificial fugitive material 228 and a first conductive additive 230. The mixture when applied can leave a dense layer 232 of the conductive additive 230 to shield the current collector from the battery electrolyte when the electrode is in use. A second mixture layer 250 is then applied over the first mixture layer 220 at an interface 248. The second mixture layer 250 can include a second redox active material 254, a second sacrificial fugitive material 260, and a second conductive additive 264. The particles of the second sacrificial material 260 can be larger than the particles of the first redox active material 228, such that when both sacrificial fugitive materials are removed, the pores distal to the current collector and created by the second sacrificial fugitive material 260 are larger than the pores created by the first sacrificial fugitive material 228. This will better allow flow of the electrolyte into and from the electrode 200.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A method of making a porous battery electrode, comprising the steps of:
forming a mixture comprising a redox active electrode material, a conductive additive, and a sacrificial fugitive material dispersed in a solvent;
applying the mixture on a current collector;
drying to evaporate the solvent; and,
removing the sacrificial fugitive material, the removed sacrificial fugitive material creating pores in the redox active electrode material, and forming a porous battery electrode with a porosity greater than 30%.

2. The method of claim 1, wherein the applying step comprises at least one selected from the group consisting of cast, coating, and printing.

3. The method of claim 1, wherein the removing step comprises at least one selected from the group consisting of volatilization, solubilization, and decomposition.

4. The method of claim 3, wherein the decomposition step comprises heating the mixture.

5. The method of claim 1, wherein the porosity of the electrode is 30-70%.

6. The method of claim 1, wherein the tortuosity of the electrode is from 1-6.

7. The method of claim 1, wherein the porosity of the electrode is 50-70% and the tortuosity of the electrode is 1.5-3.

8. The method of claim 1, wherein the electrode is a cathode and the redox active electrode material comprises at least one selected from the group consisting of LiFePO₄, LiCoO₂, LiNi_{1-x-y}Co₁₋ₓMn_{y}O₂ (x<1 and y<1 and x+y<0.98), Li_{1.2}MnₓTi_{y}O₃F (x<1, y<1 and x+y=1), NCA (LiNi_{0.85}Al_{0.05}Co_{0.1}O₂), NaFeO₂, NaCoO₂, LiNi_{1/3}Mn_{1/3}Co_{1/3}O₂, Li(CoAl)₁O₂, Li_{1.2}(MnNiCo)_{0.8}O₂, LiMn₂O₄, Li₂MnO₃, LiMn_{1.5}Ni_{0.5}O₄, LiFePO₄, LiCoPO₄, LiNiPO₄, LiNiO₂, Li-V-O, Li₂Si—Mn, Fe, Ni—O₄, NaCrO₂, Na(Fe,Mn,Ni,Co)O₂, and Na₂(Ni,Fe,Mn)O₄.

9. The method of claim 1, wherein the electrode is an anode and the redox active electrode material comprises at least one selected from the group consisting of graphite, silicon, tin, antimony, aluminum, phosphorous, platinum, gold, indium, Cu₂Sb, Mo₃Sb₇, and Cu₆Sn₅.

10. The method of claim 1, wherein the sacrificial fugitive material is natural and comprises at least one selected from the group consisting of starches, gums, mosses, peptides and fats.

11. The method of claim 10, wherein the sacrificial fugitive material is a starch comprising at least one selected from the group consisting of rice, potato, corn, and wheat.

12. The method of claim 10, wherein the sacrificial fugitive phase is a gum comprising at least one selected from the group consisting of xanthan, carrageenan, chitosan, chitin, gelatin, and guar.

13. The method of claim 10, wherein the sacrificial fugitive material is a moss comprising at least one selected from the group consisting of Irish Moss and lignin.

14. The method of claim 10, wherein the sacrificial fugitive material is a peptide and comprises at least one selected from the group consisting of alginic acid and glycine.

15. The method of claim 10, wherein the sacrificial fugitive material is a fat and comprises lecithin.

16. The method of claim 1, wherein the sacrificial fugitive material is synthetic and comprises at least one selected from the group consisting of poly methyl methacrylate, styrene, polyvinyl alcohol, latex, polyethylene oxide, polyethylene glycol.

17. The method of claim 1, wherein the sacrificial fugitive material comprises spherical particles with a diameter between 100 nm and 30 micrometers.

18. The method of claim 1, wherein the sacrificial fugitive material comprises ellipsoidal particles with an aspect ratio of 1 to 0.3.

19. The method of claim 1, wherein the sacrificial fugitive material comprises at least two sizes, a larger size and a smaller size, and wherein the larger size and the smaller size are made from different sacrificial fugitive materials having different decomposition temperatures.

20. The method of claim 1, further comprising a polymer binder.

21. The method of claim 20, wherein the molecular weight (MW) of the binder is MW >20,000.

22. The method of claim 20, wherein the electrode is for an anode, and the binder comprises at least one selected from the group consisting of polyimide, polyacrylic acid, cellulose, carboxy methyl cellulose, cellulose derivatives, propanol, polyvinyl difluoride, and styrene butyl rubber.

23. The method of claim 20, wherein the electrode is for a cathode, and the binder comprises at least one selected from the group consisting of polyimide, polyvinyl difluoride, carboxy methyl cellulose, cellulose derivatives, and styrene butyl rubber.

24. The method of claim 20, wherein the decomposition temperature of the sacrificial fugitive material is below the decomposition temperature of the binder.

25. The method of claim 1, wherein the electrode comprises a conductive additive comprising carbon, and a decomposition temperature of the sacrificial fugitive phase is below the decomposition temperature of the carbon in the conductive additive in the electrode.

26. The method of claim 1, wherein the decomposition temperature of the sacrificial fugitive material is from 250° C. to 350° C.

27. The method of claim 1, wherein the solvent is a high dielectric solvent.

28. The method of claim 27, wherein the high dielectric solvent comprises at least one selected from the group consisting of n-methyl pyrrolidone, water, ethanol, dimethyl formamide, and xylene.

29. The method of claim 1, wherein the sacrificial fugitive material is insoluble in the solvent.

30. The method of claim 1, wherein the mixture is a suspension, the mixture further comprising a rheological aid.

31. The method of claim 30, wherein the rheological aid has a molecular weight MW<20,000.

32. The method of claim 30, wherein the rheological aid comprises at least one selected from the group consisting of carbon black, dispersants, poly acrylic acid, cellulose, and polyimide.

33. The method of claim 1, wherein the conductive additive for an anode comprises at least one selected from the group consisting of carbon black, glassy carbon, carbon nanotubes, graphene, titanium diboride, zirconium diboride, carbon nanofibers, nickel, copper, stainless steel, and titanium.

34. The method of claim 1, wherein the conductive additive for a cathode comprises at least one selected from the group consisting of carbon black, glassy carbon, carbon nanotubes, graphene, carbon nanofibers, stainless steel, and aluminum.

35. The method of claim 1, wherein the mixture is a suspension.

36. The method of claim 1, wherein the mixture is a slurry.

37. The method of claim 36, wherein the slurry is applied to a current collector and wherein there is a preferential segregation of material forming a thin dense electrode structure at a position that is closer to the current collector and a mixture of less dense insoluble sacrificial fugitive particles, conductive additive, and binder materials at a position that is farther from the current collector.

38. The method of claim 37, comprising the step of adding a first slurry coating layer to the current collector having a first density, and adding a second slurry coating layer having a second density.

39. The method of claim 1, further comprising a second redox active material.

40. A porous battery electrode comprising a porosity greater than 30-70 and a tortuosity of from 1-6.

41. A battery comprising the porous battery electrode comprising a porosity greater than 30% and a tortuosity of from 1-6, a counter electrode, a separator, and an electrolyte.
